(19) United States
(12) Patent Application Publication
(10) Pub. No.: US 2023/0113267 A1
(43) Pub. Date: Apr. 13, 2023

(54) ORGANIC PEROXIDE FORMULATIONS FOR MODIFICATION OF BIO-BASED AND BIODEGRADABLE POLYMERS

(71) Applicant: Arkema Inc., King of Prussia, PA (US)

(72) Inventors: Leonard H. PALYS, King of Prussia, PA (US); Peter R. DLUZNESKI, King of Prussia, PA (US); Michael B. ABRAMS, King of Prussia, PA (US); Marina DESPOTOPOULOU, King of Prussia, PA (US); William P. PAVLEK, King of Prussia, PA (US)

(21) Appl. No.: 17/914,379

(22) PCT Filed: Apr. 8, 2021
(86) PCT No.: PCT/US2021/026421

§ 371 Date: Sep. 26, 2022

Related U.S. Application Data
(60) Provisional application No. 63/007,451, filed on Apr. 9, 2020.

(51) Int. Cl. C08K 5/14; C08L 67/04

(52) U.S. Cl. CPC C08K 5/14; C08L 67/04; C08L 2201/06

(57) ABSTRACT

Formulations for producing modified bio-based polymers, especially bio-based polyesters like PLA and/or biodegradable polymers like PBAT, include at least one organic peroxide and at least one bio-based reactive additive. The at least one organic peroxide and/or the at least one bio-based reacted additive are capable of reacting with a bio-based polymer and/or biodegradable polymer to produce the modified bio-based and/or modified biodegradable polymer. The modified bio-based and/or modified biodegradable polymers have improved properties compared to non-modified bio-based and/or biodegradable polymers. The improved properties may related to processability, especially improved melt strength which results in easier processing while producing foamed polymers, thin films, such as blown film, cast film, tentered film and the like. The improved properties may be related to physical properties such as improved stiffness, toughness or tensile strength.

### FIELD OF THE INVENTION

This disclosure relates to organic peroxide formulations for producing bio-based polymers, especially bio-based polyesters. The bio-based polymers have improved properties compared to non-modified bio-based polymers, including improved processability, and improved melt strength, which results in easier processing while producing thin films, such as blown film, cast film, tentered film and the like as well as foamed products. The improved properties also may be related to physical properties, including improved melt strength, stiffness, toughness or tensile strength.

### BACKGROUND OF THE INVENTION

Bioplastics (also called biopolymers) are a general class of plastics that include bio-based polyesters. Biopolyesters include polylactic acid (PLA), polyglycolic acid (PGA), poly-ζ-caprolactone (PCL), polyhydroxybutyrate (PHB), and poly(3-hydroxy valerate).

PLA is compostable with a 160° C. melting point offering the potential to replace petroleum based polymers, e.g. poly(styrene) or poly(methyl methacrylate), using existing polymer processing equipment. The rheology of poly(lactic acid), however, is quite different at higher processing temperatures and shear rates. PLA film production can be more difficult due to its low melt strength.

One aspect of this invention is to increase the melt strength of PLA and/or its extensional strength and viscosity, especially at higher temperatures. Another aspect of this invention is to preserve the bio-based nature of the improved PLA polymer.

WO 97/47670 discloses a method for grafting itaconic acid onto PLA using organic peroxides.

WO08081639A1 discloses an accelerator for stereocomplex formation of a polylactic acid, which contains at least one epoxy compound selected from the group consisting of aliphatic cyclic epoxies and epoxidized soybean oils (ESO), at least one acid anhydride selected from the group consisting of succinic anhydride, maleic anhydride, phthalic anhydride and trimellitic anhydride, and at least one organic peroxide selected from the group consisting of peroxyketals, hydroperoxides, peroxydicarbonates and peroxyesters.

U.S. 5,359,026 discloses the use of a wide variety of epoxidized animal and vegetable fats including epoxidized soybean oil.

U.S. 5,518,730 discloses the use of biodegradable polymers that can encapsulate a wide variety of medicines, vitamins, etc. for controlled release as the biopolymer degrades. The “bio effective actives” or medicines are encapsulated by these polymers but are not otherwise altered by the polymer.

### SUMMARY OF THE INVENTION

An organic peroxide formulation for producing a modified bio-based polymer or a modified biodegradable polymer, or a mixture thereof, is provided. The formulation comprises at least one organic peroxide and at least one reactive bio-based additive. The amount of the reactive bio-based additive and the amount of the at least one organic peroxide are selected such that the formulation is capable of chemically reacting with a bio-based polymer to produce the modified bio-based polymer, a biodegradable polymer to produce a modified biodegradable polymer, or a mixture of modified bio-based and modified biodegradable polymers.

The applicants have discovered that select organic peroxides may be used in combination with the bio-based reactive additives to improve the rheology (including melt strength) and/or final properties of a bio-based polymer such as PLA. These organic peroxide formulations combined with PLA or other bio-based polymer or other biodegradable polymers (such as poly(butylene adipate-co-terephthalate) also known as polybutyrate or PBAT), may be melt blended (e.g., in an extruder) or other type of suitable polymer melt blending or polymer processing equipment to produce the desired improvement in the poly(lactic acid) or other bio-based and/or biodegradable polymers. Other improvements include higher melt strength than the unmodified polymer, improved tensile strength, higher impact strength, more or less elongation to break depending on desired end use, better clarity, higher heat distortion temperature, higher or lower polymer surface free energy depending upon the end use, higher or lower polarity depending upon the desired end use, higher or lower elasticity depending upon the desired end use, higher (or lower) glass transition temperature depending on desired end use, long chain branching, and better compatibility with other polymers.

Other improvements that may be provided include process improvements during the polymer modification process. Certain bio-based reactive additives may act as scorch retarders to provide temporary delays in the peroxide reaction with the bio-based and/or biodegradable polymer, thereby providing extra time, sometimes a few seconds more of mixing at elevated temperatures, which results in a more uniform melt mixing of all reactive additives (in an extruder for example) just prior to the desired bio-based and/biodegradable polymer modification. A more uniform or complete blending of all reactive additives into the bio-based and/or biodegradable polymer melt, prior to polymer modification, will result in a more uniformly modified bio-based and/or modified biodegradable polymer and as a result, the final modified polymer will have more uniform physical properties.

It is further contemplated that the select bio-based reactive additives of this invention are grafted onto the bio-based polymer to impart reactive functionality to the bio-based polymer.

PLA tends to be incompatible with polyolefins (polypropylene and polyethylene), styrenic polymers such as polystyrene, acrylonitrile butadiene styrene (ABS) and high impact polystyrene (HIPS), higher molecular weight polypropylene oxide polymers, and polycarbonate. Melt blends of incompatible polymers usually have poorer physical properties, e.g., lower tensile strength. Modifying PLA according to the present invention also may improve PLA's compatibility with various petroleum based polymers.

Improvements to the properties of bio-based polymers may enable the manufacture of a wide variety of commercial products from these bio-based and/or biodegradable materials either alone or in blends with other polymers via blown film production, extrusion, thermoforming, making polymer foam, blow molding, rotational molding, compression molding and/or injection molding.

### DESCRIPTION OF THE DRAWINGS

FIG. 1. (Example 4). Rheographs showing the benefit of using Vitamin K1 plus Vitamin K2 to provide a desirable delay in the modification of PLA when using a blend of Luperox® DTA and TAIC coagent.

FIG. 2. (Example 4). Rheographs showing the benefit using Vitamin K3 to provide a desirable delay in the modification of PLA when using a blend of Luperox® DTA and TAIC coagent.

FIG. 3. (Example 5). Rheographs showing how Omega 3 and limonene can be used to provide a desirable delay in the modification of PLA when using Luperox® TBEC organic peroxide.

FIG. 4. (Example 6). Rheographs showing how tung oil increases elastic modulus of PLA when blended with an organic peroxide Luperox® TBEC.

FIG. 5. (Example 6). Rheographs showing how L-cystine, cellulose acetate butyrate (CAB) and tung oil increase the elastic modulus of PLA when blended with organic peroxide Luperox® TBEC.

FIG. 6. (Example 7). Rheographs showing how L-cystine amino acid increases the elastic modulus of PLA when blended with organic peroxide Luperox® 101.

FIG. 7. (Example 7). Rheographs showing how L-cysteine amino acid increases the elastic modulus of PLA when blended with organic peroxide Luperox® 101.

FIG. 8. (Example 7). Rheographs showing how tung oil increases the elastic modulus of PLA when blended with organic peroxide Luperox® 101.

FIG. 9. (Example 8). Reographs showing how Myrcene provides a desirable delay in the modification reaction of PLA while also increasing PLA's elastic modulus of PLA when blended with organic peroxide Luperox® 101.

FIG. 10. (Example 9). Rheographs showing how Myrcene when blended with SR350 (TMPTA) and organic peroxide Luperox® 101 provides a desirable increase in elastic modulus of PLA while also providing a desirable delay in the modification reaction of PLA versus the singular use of 1.0 wt % Luperox®101 peroxide.

FIG. 11. (Example 10). Rheographs showing how Myrcene when blended with TAIC (triallyl isocyanurate), Luperox® 101, and Vitamin K3 provides a desirable increase in the elastic modulus of PLA while also providing a desirable delay in the modification reaction of PLA versus the use of Luperox®101 peroxide and TAIC coagent.

FIG. 12. (Example 11). Rheographs showing how tung oil when blended with or without Vitamin K3 can provide a desirable increase in the elastic modulus of PLA when blended with Luperox®101. The addition of the Vitamin K3 provided a desirable delay in the modification of PLA versus the use of tung oil and peroxide used alone.

FIG. 13. (Example 12). Rheographs showing how oleuropein, Omega 3 and Vitamin K3 provided a desirable delay in the increase in the elastic modulus of PLA when blended with Luperox® DTA peroxide and TAIC (triallyl isocyanurate) coagent.

FIG. 14. (Example 13). Rheographs showing how CBD isolate provided a desirable delay and a way to control the increase in the elastic modulus of PLA when blended with Luperox® DTA peroxide and TAIC (triallyl isocyanurate) coagent.

FIG. 15. (Example 14). Rheographs of Luperox® 101 extended on silica to form a free-flowing powder, which was blended with powdered Vitamin K3 to form a peroxide composition which provided a desirable delay in the modification of PLA when using a reactive triacrylate type coagent, SR351H (TMPTA).

FIG. 16. (Example 15). Rheographs showing how tung oil was used to provide a desirable increase in the elastic modulus of a PLA:PBAT bio-based polymer and biodegradable polymer blend using Luperox® 101.

### DETAILED DESCRIPTION

Unless otherwise indicated, all percentages herein are weight percentages.

“Polymer” as used herein, is meant to include organic homopolymers and copolymers with a weight average molecular weight higher than 20,000 g/mol, preferably higher than 50,000 g/mol, as measured by gel permeation chromatography.

“Bio-based polymer(s)” or “Bioplastic(s)” are used herein interchangeably and are meant to include polymers in which at least one of the monomers are from a biological source, or could be obtained from a biological source, especially a plant source. Alternatively or in addition, a bio-based polymer may be considered to include polymers in which at least 10 wt %, or at least 20 wt % or at least 30 wt % or at least 40 wt %, or at least 50 wt % or at least 60 wt % or at least 70 wt % or at least 80 wt %, preferably at least 85 wt %, more preferably at least 90% ,and even more preferably 100% of the monomers are from biological sources and/or could be obtained from biological sources, especially a plant source. The remaining monomers may be from non-biological sources, e.g. they may be synthetically produced monomers such as monomers produced from petroleum or fossil fuel.

Biodegradable polymers break down by a bacterial decomposition process to result in at least one or more natural byproducts such as gases, water, biomass, and/or inorganic salts, Biodegradable polymers/biodegradable copolyesters can be found naturally or have been created synthetically from polymers and/or monomers derived from fossil fuels and are within the scope of the present invention, unless stated otherwise. These fossil fuel polymers can be biodegraded by microorganisms and their corresponding enzymes under appropriate conditions in an industrial composting plant. A non-limiting example is poly(butylene adipate-co-terephthalate) (PBAT), also known as polybutyrate. PBAT is a biodegradable aliphatic-aromatic copolyester based on the monomers 1,4-butanediol, adipic acid and terephthalic acid all of which are derived from fossil fuel. PBAT polymers can be melt blended with the renewable bio-based polymers such as PLA.

Bio-based polymers or bioplastics typically are produced from renewable biomass sources, such as vegetable fats and oils, corn starch, straw, woodchips, sawdust, and recycled food waste. Bio-based polymers can be made from agriculturally produced plants and by-products thereof and also from used or recycled plastics. Bio-based plastics further include materials derived from enzymatic and/or microbial processes, including but not limited to genetically modified microorganisms.

Polylactide or poly(lactic acid)(PLA) is an aliphatic biopolyester produced from the monomer lactic acid and/or its lactide. Lactic acid is found in plants as a by-product or intermediate product of their metabolism. Lactic acid can be industrially produced from a number of starch or sugar-containing agricultural products, such as cereals and sugar cane.

There are several different types of poly(lactic acid) including racemic poly-(L-lactic acid) (PLLA), regular poly-(L-lactic acid) (PLLA), poly-D-lactic Acid (PDLA), and poly-DL-lactic acid (PDLLA). They are produced from a renewable resource (lactic acid: C₃H₆O₃) as opposed to traditional plastics which are derived from nonrenewable petroleum.

“Modified bio-based polymer” as used herein means a bio-based polymer that is the product of a chemical reaction between a bio-based polymer and at least one organic peroxide formulation of the invention.

“Modified biodegradable polymer” as used herein means a biodegradable polymer that is the product of a chemical reaction between a biodegradable polymer and at least one organic peroxide formulation of the invention.

“Bio-based reactive additives” as used herein means a bio-based additive capable of reacting with the organic peroxide and/or the bio-based polymer and/or biodegradable polymers that comprise the formulation for producing a modified bio-based polymer or a modified biodegradable polymer. Bio-based reactive additives are understood to comprise such additives in which at least one of the reactants used to produce the reactive additive, or the reactive additive itself, are derived or are derivable from at least one biological source, especially a plant source. It is understood that the “Bio-based reactive additives” disclosed in this invention are organic compounds, which while available from natural sources may also be that which may be synthesized from petroleum based/fossil fuel chemicals. Accordingly, all “bio-based reactive additives” which are synthesized from non-bio-based chemicals, but which may otherwise be sourced, extracted or derived from biological sources or processes also are considered “bio-based additives” and are part of this invention, albeit less preferred.

This invention is further directed to the use of organic peroxide formulations for producing a modified bio-based polymer or a modified biodegradable polymer, or a mixture thereof, comprising, consisting of, or consisting essentially of, at least one organic peroxide and at least one reactive bio-based additive. The amount of the reactive bio-based additive and the amount of the at least one organic peroxide are selected such that the formulation is capable of chemically reacting with a bio-based polymer to produce the modified bio-based polymer or a biodegradable polymer to produce the modified biodegradable polymer. The formulation for producing a modified bio-based polymer or a modified biodegradable polymer may be liquid or solid at ambient temperatures of from 20-30° C. Formulations that are free flowing solids (powders, granules or compressed pellets) at ambient conditions may be preferred, depending on the type of equipment used.

Organic Peroxides:

Organic peroxides suitable for use in the practice of this invention may be selected from room temperature stable organic peroxides or functionalized organic peroxides to improve the rheology of PLA or other bio-based polymers while maintaining its bio-based nature. The organic peroxides suitable for the practice of the invention herein should be capable of decomposing and forming reactive free radicals when exposed to a source of heat, for example in an extruder. The organic reactive free radicals formed from the peroxides should be capable of reacting with either or both of the bio-based polymer and/or biodegradable polymer and the bio-based additive to produce the modified bio-based polymer and/or biodegradable polymer.

The organic peroxide suitable for use in certain embodiments of the formulation for producing the modified bio-based polymer and/or biodegradable polymer may be selected from those room temperature stable peroxides that possess a carbon-carbon double bond capable of free-radical reaction, carboxylic acid, methoxy or hydroxy functionality. Room-temperature stable in the context of this disclosure means an organic peroxide that has not decomposed to a significant extent, i.e., have retained>98% by weight of their initial assay, after at least three months at 20° C. Room temperature stable organic peroxides in the context of this disclosure may be defined as having a half-life of at least 1 hour at 98° C.

Non-limiting examples of suitable organic peroxides are diacyl peroxides, peroxyesters, monoperoxycarbonates, peroxyketals, hemi-peroxyketals, peroxides that are solid at ambient temperature (20° C.-25° C.), solid peroxydicarbonates, dialkyl peroxide classes, t-butylperoxy classes, and t-amylperoxy classes. In addition, the use of the cyclic peroxides such as Trigonox® 301 and Trigonox® 311 peroxides from Nouryon are suitable. Suitable peroxides may be found in “Organic Peroxides” by Jose Sanchez and Terry N. Myers; Kirk Othmer Encyclopedia of Chemical Technology, Fourth Ed., Volume 18, (1996), the disclosure of which is incorporated herein by reference in its entirety for all purposes. Room temperature thermally stable functionalized peroxides with carboxylic acid, hydroxyl and/or possessing a free radical reactive unsaturated group are also suitable. The organic peroxide may contain small amounts of diluents including mineral spirits, mineral oil, or white mineral oil. The organic peroxide may also be extended on inert fillers (e.g., Burgess clay, calcium carbonate, calcium silicate, silica and cellulose acetate butyrate) or used in powder or pellet form as a peroxide masterbatch on PLA, polyhydroxybutyrate (PHB), ethylene-vinyl acetate copolymer (EVA), ethylene propylene diene rubber (EPDM), ethylene propylene rubber (EPM), polyethylene (PE), polypropylene (PP), polyamide, poly(methylmethacrylate) (PMMA), microcrystalline wax or polycaprolactone. The peroxide concentration may vary from 1 wt % to 80 wt %, preferably from 1 wt % to 60 wt %, more preferably from 1 wt % to 40 wt % of the total weight of the peroxide and extender, depending upon the commercial application. Alternately, the peroxide concentration may vary from 10 wt % to 80 wt %, or from 20 wt % to 80 wt %, or from 30 wt % to 80 wt %.

Non-limiting examples of suitable dialkyl organic peroxides are: di-t-butyl peroxide; t-butyl cumyl peroxide; t-butyl t-amyl peroxide; dicumyl peroxide; 2,5-di(cumylperoxy)-2,5-dimethyl hexane; 2,5-di(cumylperoxy)-2,5-dimethyl hexyne-3; 4-methyl-4-(t-butylperoxy)-2-pentanol; 4-methyl-4-(t-amylperoxy)-2-pentanol; 4-methyl-4-(cumylperoxy)-2-pentanol; 4-methyl-4-(t-butylperoxy)-2-pentanone; 4-methyl-4-(t-amylperoxy)-2-pentanone; 4-methyl-4-(cumylperoxy)-2-pentanone; 2,5-dimethyl-2,5-di(t-butylperoxy)hexane; 2,5-dimethyl-2,5-di(t-amylperoxy)hexane; 2,5-dimethyl-2,5-di(t-butylperoxy)hexyne-3; 2,5-dimethyl-2,5-di(t-amylperoxy)hexyne-3; 2,5-dimethyl-2-t-butylperoxy-5-hydroperoxy hexane; 2,5-dimethyl-2-i5 cumylperoxy-5-hydroperoxy hexane; 2,5-dimethyl-2-t-amylperoxy-5-hydroperoxy hexane; m/p-alpha,alpha-di(t-butylperoxy)-diisopropyl benzene; 1,3,5-tris(t-butylperoxyisopropyl)benzene; 1,3,5-tris(t-amylperoxyisopropyl)benzene; 1,3,5-tris(cumylperoxyisopropyl)benzene; di [1,3-dimethyl-3-(t-butylperoxy)butyl] carbonate; di [1,3-dimethyl-3-(t-amylperoxy)butyl] carbonate; di [1,3-dimethyl-3-(cumylperoxy)butyl] carbonate; di-t-amyl peroxide; t-amyl cumyl peroxide; t-butylperoxy-isopropenylcumylperoxide; t-amylperoxy-isopropenylcumylperoxide; 2,4,6-tri(butylperoxy)-s-triazine; 1,3,5-tri [1-(t-butylperoxy)-1-methylethyl] benzene; 1,3,5-tri-[(t-butylperoxy)-isopropyl benzene; 1,3-dimethyl-3-(t-butylperoxy)butanol; 1,3-dimethyl-3-(t-amylperoxy)butanol; and mixtures thereof. Other dialkyl type peroxides which may be used singly or in combination with the other free radical initiators contemplated by the present disclosure are those selected from the group represented by the formula:

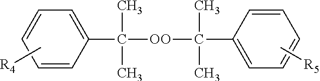

wherein R₄ and R₅ may independently be in the meta or para positions and are the same or different and are selected from hydrogen or straight or branched chain alkyls of 1 to 6 carbon atoms. Dicumyl peroxide and isopropylcumyl cumyl peroxide are illustrative.

Functionalized dialkyl type peroxides may include but are not limited to: 3-cumylperoxy-1,3-dimethylbutyl methacrylate; 3-t-butylperoxy-1,3-dimethylbutyl methacrylate; 3-t-amylperoxy-1,3-dimethylbutyl methacrylate; tri(1,3-dimethyl-3-t-butylperoxy butyloxy)vinyl silane; 1,3-dimethyl -3-(t-butylperoxy)butyl N-[1-{3-(1-methylethenyl)-phenyl}-1-methylethyl]carbamate; 1,3-dimethyl-3-(t-amylperoxy)butyl N-[1-{3(1-methylethenyl)-phenyl}-1-methylethyl]carbamate; 1,3-dimethyl-3-(cumylperoxy))butyl N-[1-{3-(1-methylethenyl)-phenyl}-1-methylethyl]carbamate.

Difunctional dialkyl type peroxides containing two different types of peroxide groups of varying chemical and/or thermal reactivity: 2,5-dimethyl-(2-hydroperoxy-5-t-butylperoxy)hexane; t-butyl t-amyl peroxide and 2,5-dimethyl-(2-hydroperoxy-5-t-amylperoxy)hexane.

In the group of diperoxyketal type organic peroxides, suitable compounds may include: 1,1-di(t-butylperoxy)-3,3,5-trimethylcyclohexane; 1,1-di(t-amylperoxy)-3,3,5-trimethylcyclohexane; 1,1-di(t-butylperoxy)cyclohexane; 1,1-di(t-amylperoxy)cyclohexane; n-butyl 4,4-di(t-amylperoxy)valerate; ethyl 3,3-di(t-butylperoxy)butyrate; 2,2-di(t-amylperoxy)propane; 3,6,6,9,9-pentamethyl-3-ethoxycabonylmethyl-1,2,4,5-tetraoxacyclononane; n-butyl-4,4-bis(t-butylperoxy)valerate; ethyl-3,3-di(t-amylperoxy)butyrate; and mixtures thereof.

Illustrative cyclic ketone peroxides are compounds having the general formulae (I), (II) and/or (III).

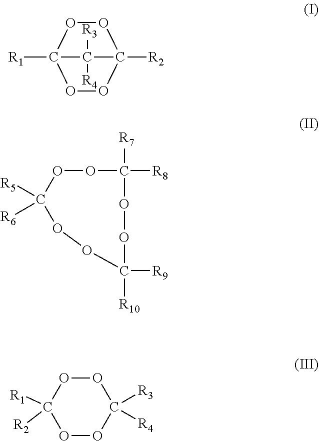

wherein R₁ to R₁₀ are independently selected from the group consisting of hydrogen, C1 to C20 alkyl, C3 to C20 cycloalkyl, C6 to C20 aryl, C7 to C20 aralkyl and C7 to C20 alkaryl, which groups may include linear or branched alkyl properties and each of R1 to R10 may be substituted with one or more groups selected from hydroxy, C1 to C20 alkoxy, linear or branched C1 to C20 alkyl, C6 to C20 aryloxy, halogen, ester, carboxy, nitride and amido.

Some non-limiting examples of suitable cyclic ketone peroxides include but are not limited to: 3,6,9 triethyl-3,6,9-trimethyl-1,4,7-triperoxynonane (or methyl ethyl ketone peroxide cyclic trimer), methyl ethyl ketone peroxide cyclic dimer, and 3,3,6,6,9,9-hexamethyl-1,2,4,5-tetraoxacyclononane.

Non-limiting illustrative examples of peroxyesters include: 2,5-dimethyl-2,5-di(benzoylperoxy)hexane; t-butylperbenzoate; t-butylperoxyacetate; t-butylperoxy-2-ethyl hexanoate; t-amylperbenzoate; t-amyl peroxy acetate; t-butyl peroxy isobutyrate; 3-hydroxy-1,1-dimethyl t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy)propionate; ally 3-methyl-3-t-butylperoxy butyrate. Illustrative monoperoxy carbonates include: OO-t-butyl-O-isopropylmonoperoxy carbonate; OO-t-amyl-O-isopropylmonoperoxy carbonate; OO-t-butyl-O-(2-ethyl hexyl)monoperoxy carbonate; OO-t-amyl-O-(2-ethyl hexyl)monoperoxy carbonate; 1,1,1-tris[2-(t-butylperoxy-carbonyloxy)ethoxymethyl]propane; 1,1,1-tris[2-(t-amylperoxy-carbonyloxy)ethoxymethyl]propane; 1,1,1-tris[2-(cumylperoxy-carbonyloxy)ethoxymethyl]propane. For example, Luperox® JWEB™ is a tetrafunctional polyether tetrakis(t-butylperoxy monoperoxycarbonate) and Luperox® V10 whose chemical name is 1-methoxy-1-t-amylperoxy hexane, (both from Arkema) are suitable for this application.

Other peroxides that may be used according to at least one embodiment of the present disclosure include the functionalized peroxyester type peroxides: OO-t-butyl-O-hydrogen-monoperoxy-succinate; OO-t-amyl-O-hydrogen-monoperoxysuccinate; OO-t-amylperoxymaleic acid and OO-t-butylperoxymaleic acid.

Also suitable in the practice of this invention is an organic peroxide branched oligomer comprising at least three peroxide groups comprises a compound represented by structure below:

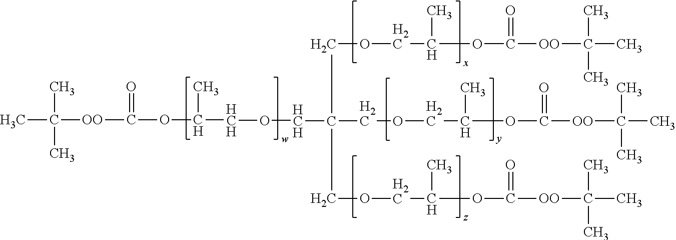

In the above structure, the sum of W, X, Y and Z is 6 or 7. One example of this type of uniquely branched organic peroxide is the tetrafunctional polyether tetrakis(t-butylperoxy monoperoxycarbonate) known as Luperox® JWEB50 (Arkema).

Illustrative hemi-peroxyketal class of organic peroxides include: 1-methoxy-1-t-amylperoxycyclohexane (Luperox® V10); 1-methoxy-1-t-butylperoxycyclohexane; 1-methoxy-1-t-amylperoxy-3,3,5 trimethylcyclohexane; 1-methoxy-1-t-butylperoxy-3,3,5 trimethylcyclohexane.

Illustrative diacyl organic peroxides include but are not limited to: di(4-methylbenzoyl)peroxide; di(3-methylbenzoyl)peroxide; di(2-methylbenzoyl)peroxide; didecanoyl peroxide; dilauroyl peroxide; 2,4-dibromo-benzoyl peroxide; succinic acid peroxide; dibenzoyl peroxide; di(2,4-dichloro-benzoyl)peroxide. Imido peroxides of the type described in PCT Application publication WO9703961 A1 are also contemplated as suitable for use and incorporated by reference herein for all purposes.

Functionalized organic peroxides are suitable for use in the formulation for producing the modified bio-based polymer. Non-limiting examples of functionalized peroxides are t-butylperoxy maleic acid and t-butylperoxy-isopropenylcumylperoxide. Both contain unsaturation, and the former also has carboxylic acid functionality.

Illustrative solid, room temperature stable peroxydicarbonates include, but are not limited to: di(2-phenoxyethyl)peroxydicarbonate; di(4-t-butyl-cyclohexyl)peroxydicarbonate; dimyristyl peroxydicarbonate; dibenzyl peroxydicarbonate; and di(isobornyl)peroxydicarbonate. An example of a solid peroxydicarbonate is Perkadox® 16 by Nouryon whose chemical name is di(4-tert-butyl cyclohexyl) peroxydicarbonate.

Non-limiting examples of preferred organic peroxides include dilauryl peroxide; 2,5-di-methyl-2,5-di(t-butylperoxy)hexane; 2,5-di-methyl-2-t-butylperoxy-5-hydroperoxy hexane; di-t-butyl peroxide; di-t-amyl peroxide; 1,1-di(t-butylperoxy)-3,3,5-trimethylcyclohexane; 1,1-di(t-butylperoxy)cyclohexane; 1,1-di(t-amylperoxy)cyclohexane; OO-t-butyl-O-isopropylmonoperoxy carbonate; OO-t-amyl-O-isopropylmonoperoxy carbonate; OO-t-butyl-O-(2-ethyl hexyl)monoperoxy carbonate; OO-t-amyl-O-(2-ethyl hexyl)monoperoxy carbonate; t-butylperoxy maleic acid; t-butylperoxy-isopropenylcumylperoxide; 1-methoxy-l-t-amylperoxycyclohexane; polyether tetrakis(t-butylperoxy monoperoxycarbonate); m/p-di(t-butylperoxy)diisopropyl-benzene; t-butylcumylperoxide; 3,6,9, triethyl-3,6,9-trimethyl-1,4,7-triperoxynonane (or methyl ethyl ketone peroxide cyclic trimer) or Trigonox® 301 from Nouryon; and 3,3,5,7,7-pentamethyl-1,2,4-trioxepane or Trigonox® 311 from Nouryon; and blends thereof.

Reactive Bio-Based Additives:

Non-limiting examples of suitable reactive bio-based additives include those that are capable of either reacting directly with the bio-based polymer and/or biodegradable polymer, or those that are capable of reacting with the organic peroxide to produce a compound or a residue capable of reacting with the bio-based polymer and/or biodegradable polymer. Also suitable are additives that may be capable of reacting both with the bio-based polymer and/or biodegradable polymer and with the organic peroxide that comprise the organic peroxide formulation for producing a modified bio-based polymer and/or biodegradable polymer.

Suitable bio-based additives include in certain embodiments natural fatty acids that comprise at least one double bond (i.e., unsaturated natural fatty acids), saturated natural fatty acids, or a combination thereof. Non-limiting examples of plant or animal-sourced or bio-based unsaturated oils useful as the bio-based additive include myrcene, tung oil, oiticica oil, and olive is leaf oil (oleuropein). Plant or animal sourced fatty acid alkyl esters that comprise at least one carbon-carbon double bond are suitable to be used in embodiments of the invention as disclosed here. Such fatty acid esters may include a C1 to C8 alkyl ester of a C8-C22 fatty acid. In one embodiment, fatty acid alkyl esters of vegetable oils such as fatty acid alkyl esters of olive oil, peanut oil, corn oil, cottonseed oil, soybean oil, linseed oil, and/or coconut oil are used. In one embodiment, methyl soyate is used. In other embodiments, the fatty acid alkyl ester may be selected from the group consisting of biodiesel and derivatives of biodiesel. In another embodiment, the fatty acid alkyl ester is a castor oil-based fatty acid alkyl ester. The alkyl group present in the fatty acid alkyl ester may be, for example, a C1-C6 straight chain, branched or cyclic aliphatic group such as methyl, ethyl, n-propyl, isopropyl, n-butyl, sec-butyl, cyclohexyl and the like. The fatty acid alkyl ester may comprise a mixture of esters containing different alkyl groups. The bio-based reactive additives may be selected from fatty acids or derivatives thereof, monoglycerides, diglycerides, triglycerides, animal fats, animal oils, vegetable fats, or vegetable oils or combinations thereof. Examples of such bio-based reactive additives include, without limitation, linseed oil, soybean oil, cottonseed oil, ground nut oil, sunflower oil, rapeseed oil, canola oil, sesame seed oil, olive oil, com oil, safflower oil, peanut oil, sesame oil, hemp oil, neat's food oil, whale oil, fish oil, castor oil, or tall oil, or combinations thereof. Also suitable are: algae oil, avocado oil, castor oil, flax oil, fish oil, grapeseed oil, hemp oil, cannabidiol (CBD), thymol, jatropha oil, jojoba oil, mustard oil, dehydrated castor oil, palm oil, palm stearin, rapeseed oil, safflower oil, tall oil, olive oil, tallow, lard, chicken fat, linseed oil, linoleic oil, coconut oil and mixtures thereof. Epoxidized versions of any of the preceding natural oils may also be utilized in the formulation for producing a modified bio-polymer. Of these, preferred bio-based additives include olive oil, olive leaf oil (oleuropein), hemp oil, myrcene, cannabidiol (CBD); tung oil, thymol, limonene, and oiticica oil. More preferred bio-based compounds are hemp oil, myrcene, cannabidiol (CBD Isolate) a purified solid form of CBD which does not contain psychoactive THC, tung oil, oleuropein and limonene. Even more preferred is tung oil.

Non-limiting examples of saturated or highly-saturated fatty acid esters or oils are naturally occurring or bio-based or bio-derived butyric fatty acid and esters thereof, lauric acid and esters thereof, myristic acid and esters thereof, palmitic acid and esters thereof, palm kernel oil, palm oil and esters thereof, stearic acid and esters thereof. Of these, preferred are lauric acid, myristic acid and palmitic acid and their esters thereof.

Other suitable bio-based reactive additives are the natural fatty amines, preferably primary amines comprising at least one double bond. Non-limiting examples of these additives include the preferred: oleylamine; elaidylamine; coco amine; and soya amine. Saturated fatty amines may be used as well and non-limiting examples include pentadecylamine; stearyl amine; and lauryl amine.

Various commercial aliphatic primary amines supplied by NOF Corporation under the tradename of NISSANAMIINE® include lauryl amine, coconut alkyl amine, myristyl amine, palmityl amine, and stearyl amine, as well as hardened tallow alkyl amine, oleyl amine, and soybean alkyl amine are non-limiting examples of reactive bio-based additives suitable for the practice of this invention.

Naturally-occurring or bio-based or bio-derived terpenes and derivatives thereof are also suitable to be used as the bio-based reactive additive in the formulation for producing a modified bio-based polymer. Monoterpenes, monoterpenoids, modified monoterpenes, diterpenes, modified diterpenes, triterpenes, modified triterpenes, triterpenoids, sesterterpenes, modified sesterterpenes, sesterterpenoids, sesquarterpenes modified sesquarterpenes, sesquarterpenoids, and oxygen-containing derivatives of hemiterpenes, are also non-limiting examples of suitable bio-based reactive additives that may be included in the formulation for producing a modified bio-based polymer. Non-limiting particular examples of such reactive bio-based additives are limonene, myrcene, carvone, humulene, taxidiene, squalene, farnesenes, farnesols, cafesrol, kahweol, cembrene, taxidiene, retinol, retinal, phytol, geranylfarnesol, shark liver oil, licopene, ferrugicadiol, and tetraprenylcurcumene, gamma-carotene, alpha-carotene, and beta-carotene. Epoxidized versions of these terpenes are also suitable. Preferred terpenes include limonene and myrcene.

Vitamins, or derivatives thereof having at least one carbon-carbon double bond may be used as the bio-based reactive additive in embodiments of the formulation for producing a modified bio-based polymer. Non-limiting examples are vitamin B complex type compounds and derivatives thereof, particularly folic acid, vitamin B12, vitamin B1 (thiamine), as well as vitamin K and forms and derivative thereof: for example vitamin K1 (phytonadione), vitamin K2 (menaquinone, menaquinone-4 and menaquinone-7) and vitamin K3 (menadione).

Other bio-based reactive additives useful in the formulation for producing a modified bio-based and/or biodegradable polymer disclosed include raw honey, honey, glucose, fructose, sucrose, galactose, arabinose, fructose, fucose, galactose, inositol, maltodextrin, saccharose, dextrose, lactose, maltose, ribose, mannose, rhamnose, xylose, glycerine and urea.

Certain amino acids may also be used as the bio-based reactive additive in the formulation for producing a modified bio-based polymer and/or modified biodegradable polymer. These may be particularly efficacious since the amino group or groups on these compounds may react directly with the poly(lactic acid), for example. Those amino acids comprising at least two amino groups are preferred. Non-limiting examples of suitable preferred amino acids are arginine, lysine, glutamine, histadine, cysteine, cystine, serotonin, asparagine, glutamic acid, glycine, aspartic acid, serine, threonine and tryptophan. More preferred amino acids are the sulfur containing amino acids for example cysteine, homocysteine and cystine.

Other bio-based reactive additives that may be included in the formulation to produce the modified bio-based polymer and/or modified biodegradable polymer are for example, a blend of epoxidized bio-based oil and bio-sourced itaconic acid or anhydride. In place of the epoxidized bio-based oil, un-epoxidized bio-based oil may be used. A blend of epoxidized soybean oil and bio-based itaconic acid are contemplated. Other bio-based acids may also be used, for example natural acids such as abietic acid or tartronic acid including their corresponding anhydride forms. Also included is the methyl ester of abietic acid, which is abalyn.

Blends of epoxidized bio-based oils and di- or tri-functional acrylates and/or methacrylates coagent may be used, such as those available from Sartomer under the tradenames Sartomer®, Saret®, and Sarbio®. The latter are especially preferred since they are bio-based.

Pentaerythritol with and without the organic peroxide may be used.

Sugar alcohols may be used as the reactive bio-based additives. Non-limiting examples include erythritol, sorbitol, mannitol, maltitol, lactitol, isomalt, xylitol or other sugar alcohols. A blend of zinc oxide, magnesium oxide and/or calcium oxide with bio-based itaconic acid or anhydride and the organic peroxides disclosed herein may be used as the formulation for producing the modified bio-based polymer. Zinc-di(itaconate)salt may comprise the bio-based reactive additive. Zinc oxide blended with at least one of the amino acids described above may also be used as the bio-based reactive additive in certain embodiments.

Amounts of the Bio-Based Reactive Additive and the Organic Peroxide in the Organic Peroxide Formulation for Producing the Modified Bio-Based Polymer:

The formulation for producing the modified bio-based polymer may comprise from 0.1% to 99.9% by total weight of the formulation of the organic peroxide and from 99.9% to 0.1% by weight of the bio-based reactive additive.

According to particular embodiments, the at least one organic peroxide (based on a pure wt % basis of the at least one organic peroxide, i.e., exclusive of fillers and other additives except for the bio-based reactive additive, for these calculated ranges) may be included in the formulation for producing a modified bio-based and/or modified biodegradable polymer in an amount from 0.0001 wt % to 95 wt %, or from 0.0010 wt % to 90 wt %, or from 0.005 wt % to 80 wt %, or from 0.01 wt % to 70 wt % or from 0.01 wt % to 60 wt %, or from 0.01 wt % to 50 wt %, or from 0.01 wt % to 40 wt %, or from 0.01 wt % to 30 wt %, or from 0.01 wt % to 20 wt %, or from 0.01 wt % to 10 wt %, or from 0.01 wt % to 8.0 wt % or from 0.01 wt % to 4.0 wt % or from 0.01 wt % to 2.0 wt % or from 0.01 wt % to 1.5 wt %, or from 0.01 wt % to 1.0 wt %, or from 0.005 wt % to 1.0 wt % based on the total weight of the formulation for producing a modified bio-based polymer and/or modified biodegradable polymer. Preferred ranges are 0.01 wt % to 25 wt %, more preferred are 0.01 wt % to 20 wt %, more preferred from 0.1 wt % to 15 wt %, even more preferred are 0.01 wt % to 10 wt % on a pure peroxide wt % basis. In some embodiments at least 0.01 wt %, or at least 0.1 wt %, or at least 0.5 wt %, or at least 1 wt %, or at least 5 wt %, or at least 10 wt %, or at least 20 wt % of the at least one organic peroxide are preferred. For example, in cases where an existing 40% assay peroxide extended on an inert filler is used, higher actual weight ranges may be required as the peroxide added to the formulation is not 100% assay (pure).

According to particular embodiments, the at least one bio-based reactive additive (based on a pure wt % basis of the at least one bio-based additive, i.e., exclusive of fillers and other additives except for the organic peroxide, for these ranges) may be included in the formulation for producing a modified bio-based polymer and/or modified biodegradable polymer in an amount from 95 wt % to 0.001 wt %, or from 90 wt % to 0.01 wt %, or from 80 wt % to 0.10 wt %, or from 70 wt % to 0.1 wt % or from 60 wt % to 0.5 wt %, or from 50 wt % to 1.0 wt %, or from 40 is wt % to 1.0 wt %, or from 30 wt % to 2.0 wt %, or from 25 wt % to 2.0 wt %, or from 20 wt % to 2.0 wt %, or from 15 wt % to 2.0 wt %, or from 10 wt % to 0.10 wt %, or from 8 wt % to 0.10 wt %, or from 8 wt % to 1 wt %, or from 5.0 wt % to 0.10 wt %, from 5.0 wt % to 1.0 wt %, based on the total weight of the formulation for producing a modified bio-based polymer. Preferred ranges may be from 95 wt % to 10 wt %, preferably from 80 wt % to 10 wt %, preferably from 60 wt % to 10 wt %, more preferably 50 wt % to 10 wt %, even more preferably from 45 wt % to 15 wt %. In some embodiments the at least one bio-based additive preferred ranges may be from 0.01 wt % to 10 wt %; more preferably from 0.1 wt % to 5 wt % even more preferably from 0.1 wt % to 2 wt %.

The ratio by weight of the organic peroxide to the bio-based reactive additive may be from 1:8000 to 1000:1 or 1:6000 to 1000:1 or from 1:4000 to 100:1 or from 1:2000 to 100:1 or from 1:1000 to 100:1 or from 1:500 to 100:1 or from 1:400 to 100:1 or from 1:250 to 100:1 or from 1:100 to 100:1, or from 1:100 to 10:1 or from 1:50 to 10:1 or from 1:25 to 10:1 or from 1:20 to 2:1 or from 1:15 to 2:1 or from 1:10 to 2:1 or from 1:5 to 2:1 or from 1:2 to 1:1. Preferred ranges are 1: 1000 to 1000:1; preferably 1:500 to 500:1; preferably 1: 100 to 100:1; preferably 1:100; preferably 1:50, preferably 1:40; preferably 1:30, preferably 1:20; more preferably 1:10, depending upon the peroxide and bio-based reactive additive chosen.

Bio-Based Polymers:

Non-limiting examples of suitable bio-based polymers are aliphatic biopolyesters such as polylactic acid (PLA), also referred to as polylactide, polyhydroxyalkanoates (PHAs), polyhydroxybutyrate (PHB), poly(3-hydroxy valerate) (PHV), polyhydroxyhexanoate (PHH), polyglycolic acid (PGA), and poly-ε-caprolactone (PCL). Polyamide 11, a biopolymer derived from natural oil (castor bean oil) may be suitable for use in certain embodiments. It is known under the tradename Rilsan® B (Arkema). Polyamide 410 (PA 410), derived 70% from castor oil, under the trade name EcoPaXX® (DSM) may be used in certain embodiments. The preferred bio-based polymers are the polylactic acid type polymers.

Bio-based polyamides may include but are not limited to aliphatic, semi-aromatic, aromatic, and/or aliphatic grafted polyamide polymers and/or copolymers and/or blends of these resins including but not limited to the following: bio-based versions of the polyamides commonly known as PA4, PA6, PA66, PA46, PA9, PA11, PA12, PA610, PA612, PA1010, PA1012, PA6/66, PA66/610, PAmXD6, PA6I; Rilsan® polyamides, Hiprolon® polyamides, is Pebax® polyether block polyamides, Platamid® copolyamides, Cristamid® copolyamides, further including but not limited to Hiprolon®70, Hiprolon®90, Hiprolon®200, Hiprolon®400, Hiprolon®11, Hiprolon®211 (all available from Arkema, Inc.). Suitable bio-based polyamides also include TERRYL brand polyamides available from Cathay Industrial Biotech, Shanghai, China (PA46, PA6, PA66, PA610, PA 512, PA612, PA514, PA1010, PAll, PA1012, PA 12, PA1212), ExcoPAXX® polyamides available from DSM, Singapore, Vestamide® polyamides available from Evonik, Germany, semi-aromatic polyamides (e.g., PA6T, poly(hexamethyleneterephthalamide), such as Trogamid® polyamides available from Evonik and Amodel® polyamides available from Solvay, Alpharetta, Ga.) or Vicnyl® polyamides including PA10T, PA9T from Kingfa Sci. & Tech Co, China, and Nylon®, Zytel® RS and “PLS” product lines (e.g., RSLC, LC including glass reinforced and impact modified grades), Elvamide® multi-polymer polyamides, Minion®, Zytel® LCPA, Zytel® PLUS polyamides from DuPont, Wilmington, Delaware, and aromatic type polyamides (e.g., poly(paraphenyleneterephthalamide), such as, Kevlar® and Nomex® polyamides from DuPont, Teijinconex®, Twaron® and Technora® polyamides from Teijin, Netherlands and Japan, and Kermel® polyamides from Kermel, Swicofil AG, Switzerland). Also suitable are the “bio-polyamide” polyamides derived using YXY building block monomers such as 2,5-furandicarboxylic acid and/or 2,5-hydroxymethyl tetrahydrofuran monomers derived from sugars (e.g., 5-hydroxymethyl furfural) from Solvay/Avantium including bio-based polyamides from Rhodia/Avantium, the Technyl® copolyamides from Solvay/Rhodia e.g., Technyl® 66/6, the hot melt adhesives Vestamelt® polyamides from Evonik, H1001w polyamide from Shanghai Farsseing Hotmelt Adhesive Co., Lanxess Durathan® polyamides e.g., Durathan® C131F PA6/6I copolyamide, Priplast®0 modified coplyamide elastomers by Croda Coatings & Polymers, Rowalit® polyamides by Rowak AG, Nylonxx® and Nylonxp® polyamides from Shanghai Xinhao Chemical Co., Ultramid® polyamide grades from BASF, Griltex® copolyamides by EMS-Griltech, and Euremelt® copolyamides from Huntsman. Blends of these materials may be used.

The term “poly(lactic acid)” (PLA) as used herein refers to a polymer or copolymer containing at least 10 mol % of lactic acid monomer units. Examples of poly(lactic acid) include, but are not limited to, (a) a homopolymer of lactic acid, (b) a copolymer of lactic acid with one is or more aliphatic hydroxycarboxylic acids other than lactic acid, (c) a copolymer of lactic acid with an aliphatic polyhydric alcohol and an aliphatic polycarboxylic acid, (d) a copolymer of lactic acid with an aliphatic polycarboxylic acid, (e) a copolymer of lactic acid with an aliphatic polyhydric alcohol, and (f) a mixture of two or more of (a)-(e) above. Examples of the lactic acid include L-lactic acid, D-lactic acid, DL-lactic acid, a cyclic dimer thereof (i.e., L-lactide, D-lactide or DL-lactide) and mixtures thereof. Examples of the hydroxycarboxylic acid, useful for example in copolymers (b) and (f) above include, but are not limited to, glycolic acid, hydroxybutyric acid, hydroxyvaleric acid, hydroxycaproic acid and hydroxyheptoic acid, and combinations thereof. Examples of the aliphatic polyhydric alcohol monomers useful for example in the copolymers (c), (e), or (f) above include, but are not limited to, ethylene glycol, 1,4-butanediol, 1,6-hexanediol, 1,4-cyclohexanedimethanol, neopentyl glycol, decamethylene glycol, glycerin, trimethylolpropane and pentaerythritol and combinations thereof. Examples of the aliphatic polycarboxylic acid monomers useful for example in the copolymers (c), (d), or (f) above include, but are not limited to, succinic acid, adipic acid, suberic acid, sebacic acid, dodecanedicarboxylic acid, succinic anhydride, adipic anhydride, trimesic acid, propanetricarboxylic acid, pyromellitic acid and pyromellitic anhydride and combinations thereof.

Biodegradable Polymers

Non-limiting examples of suitable biodegradable polymers are polybutylene succinate, polybutylene adipate, polybutylene succinate adipate, polybutylene adipate terephthalate (PBAT), polybutylene succinate terephthalate. One preferred biodegradable polymer is: polybutylene adipate terephthalate (PBAT).

Modified Bio-based Polymers and Modified Biodegradable Polymers:

A modified bio-based polymer comprising, consisting of or consisting essentially of a reaction product of: at least one organic peroxide; at least one reactive bio-based additive; and at least one bio-based polymer is provided.

A modified biodegradable polymer comprising, consisting of or consisting essentially of a reaction product of: at least one organic peroxide; at least one reactive bio-based additive; and at least one biodegradable polymer is provided.

A mixture of a modified bio-based polymer and a modified biodegradable polymer comprising, consisting of consisting essentially of a reaction product of at least one organic peroxide; at least one reactive bio-based additive; and at least one bio-based additive and at least one biodegradable polymer is provided.

While not wishing to be bound by theory, the bio-based polymer and/or the biodegradable polymer may be chemically modified by a reaction with at least one of the bio-based reactive additive or the organic peroxide as disclosed herein to produce the modified bio-based polymer and/or the modified biodegradable polymer having improved or different chemical or physical properties compared to the bio-based polymer and/or the biodegradable polymer prior to its reaction with the formulation disclosed herein. Non-limiting examples of such modifications may be additional long-chain branching of the polymer, grafting of the bio-based reactive additive to the bio-based polymer and/or the biodegradable polymer, direct reaction of the bio-based additive with the bio-based polymer and/or the biodegradable polymer, reaction of a reaction product of the bio-based reactive additive and the organic peroxide with the bio-based polymer and/or the biodegradable polymer.

Improved Properties:

Properties of the bio-based polymer and/or biodegradable polymer that may be improved or changed due to the formulation for producing a modified bio-based polymer and/or modified biodegradable polymer include but are not limited to: melt strength, stiffness, impact resistance, clarity, tensile strength, compatibility with other polymers, especially non-polar polymers whether bio-based or not, compatibility with fillers, especially bio-based fillers.

For example, the modified bio-based polymer and/or biodegradable polymer as disclosed herein may be more compatible with other polymers especially non-polar polymers, such that a polymer alloy or blend, whether homogenous or heterogeneous may be produced from the modified bio-based polymer and another polymer. Non-limiting examples of such non-polar polymers are polyolefins such as polyethylene and polypropylene, Engage® polyethylene copolymers from Dow e.g., poly(ethylene octene) and poly(ethylene hexene) copolymers, poly(ethylene propylene); poly(propylene ethylene) and other non-polar co-polymers thereof. Also suitable in certain embodiments are recycled versions of any of these materials and blends is of recycled and virgin non-polar polymers. Also contemplated are alloys or blends, whether homogeneous or heterogeneous with polystyrene, HIPS, ABS, Polyphenylene oxide (PPO)/HIPS blends (e.g. Noryl™ from GE) or fluoropolymers such as poly(vinylidene difluoride), e.g. Kynar® (Arkema) or poly(tetrafluoroethylene) or fluoropolymer that has been modified with acrylate or methacrylate type functionality. Silicone polymers and fluorosilicone polymer/elastomers are also contemplated as blends with the modified bio-polymers are disclosed herein. The modified bio-based polymer and/or biodegradable polymers disclosed herein may be more compatible with fillers or extenders or strengthening agents, or non-rubber impact modifiers than the un-modified bio-polymer. Burgess clay, fumed silica (non-crystalline type), precipitated calcium carbonate, calcium silicate and diatomaceous earth are non-limiting examples of non-rubber impact modifiers.

In some embodiments the rheology of the modified bio-based polymer and/or modified biodegradable polymer may be changed with respect to the un-modified bio-based polymer to affect the flow properties in the melt (i.e., increased melt strength). Without being limited by theory, the modified PLA may become less polar and more compatible with polyolefins. In other embodiments, without being limited by theory, it is possible that the bio-based polymer and/or biodegradable polymer may be partially crosslinked, such that it will still flow but be highly entangled. In other embodiments, without being limited by theory, the bio-based polymer and/or the biodegradable polymer may be fully crosslinked.

Other Additives:

Bio-based fillers, non-bio-based fillers, and/or stabilizers for the peroxides, whether bio-based or not may also be included in the formulation for producing a modified bio-based polymer. For example calcium carbonate, talc, silica, fumed silica, precipitated silica, calcium carbonate, clay, Burgess clay, kaolin, fly ash, powdered polyethylene, or cellulose acetate butyrate, cellulose, calcium silicate, diatomaceous earth may be used.

The formulation for producing a modified bio-based polymer and/or modified biodegradable polymer may be in the form of a solid or a liquid, depending on the form of the organic peroxide and the reactive bio-based additive. The formulation for producing a modified bio-based polymer and/or modified biodegradable polymer may comprise an inert carrier, e.g., silica, fumed silica, precipitated silica, talc, calcium carbonate, clay, Burgess clay, kaolin, fly is ash, powdered polyethylene, porous polypropylene, poly(ethylene vinylacetate) poly(methylacrylate), poly(methylmethacrylate), ethylene propylene rubber (EPM), ethylene propylene diene rubber (EPDM), polyethylene wax, microcrystalline wax, acrylate copolymers, cellulose acetate butyrate, cellulose, calcium silicate, diatomaceous earth or may be in the form of a masterbatch for ease of handling during a compounding step or for combining the formulation for producing a modified bio-based polymer with the un-modified bio-based polymer.

The formulation for producing a modified bio-based polymer and/or modified biodegradable polymer may comprise stabilizers for the organic peroxide, for example at least one quinone type compound. For this purpose, the use of at least one Vitamin K compound or derivative thereof (i.e., a family of phylloquinones that contains a ring of 2-methyl-1, 4-naphthoquinone) may be used in some embodiments. Non-limiting examples include: K1 (phylloquinone), K2 (menaquinone) or K3 (menadione) which may be used as a free-radical stabilizer and also for scorch protection, wherein scorch is defined as premature (unwanted) free-radical interaction with a polymer during compounding operations. In some embodiments, if the at least one quinone compound is used as stabilizer for the organic peroxide, at least one allylic compound, preferably a triallyl compound may also be included with the organic peroxide. In some instances, at least one sulfur containing compound, in particular at least one disulfide containing compound may be present as stabilizer for the at least one organic peroxide. Examples of preferred sulfur containing compounds are Vultac®; 2-mercaptobenzothiazole (MBTS) or zinc dialkyldithiophosphates (ZDDP) from MLPC Arkema. Elemental sulfur may also be contemplated in some embodiments.

In accordance with particular embodiments, organic peroxide formulations of the present invention may further include at least one crosslinking coagent. According to particular embodiments, examples of crosslinking co-agents include allyl methacrylate, triallyl cyanurate, triallyl isocyanurate, trimethyloylpropane trimethacrylate (SR-350®), trimethyloylpropane triacrylate (SR-351®), zinc diacrylate, and zinc dimethacrylate.

Non-limiting preferred coagents include: diethylene glycol dimethacrylate; cyclic alkane diacrylate; trimethylolpropane triacrylate; trimethylolpropane trimethacrylate; propoxylated 3 trimethylolpropane triacrylate; pentaerythritol triacrylate; pentaerythritol trimethacrylate is polybutadiene dimethacrylate and polybutadiene diacrylate.

Additional Non-Limiting Examples of Crosslinking Coagents Include:

Sartomer-manufactured methacrylate-type coagents, such as: SR205H triethylene glycol dimethacrylate (TiEGDMA), SR206H ethylene glycol dimethacrylate (EGDMA), SR209 tetraethylene glycol dimethacrylate (TTEGDMA), SR210HH polyethylene glycol (200) dimethacrylate (PEG200DMA), SR214 1,4-butanediol dimethacrylate (BDDMA), SR231 diethylene glycol dimethacrylate (DEGDMA), SR239A 1,6-hexanediol dimethacrylate (HDDMA), SR252 polyethylene glycol (600) dimethacrylate (PEG600DMA), SR262 1,12-dodecanediol dimethacrylate (DDDDMA), SR297J 1,3-butylene glycol dimethacrylate (BGDMA), SR348C ethoxylated 3 bisphenol A dimethacrylate (BPA3EODMA), SR348L ethoxylated 2 bisphenol A dimethacrylate (BPA2EODMA), SR350D trimethylolpropane trimethacrylate (TMPTMA), SR480 ethoxylated 10 bisphenol A dimethacrylate (BPA10EODMA), SR540 ethoxylated 4 bisphenol A dimethacrylate (BPA4EODMA), SR596 alkoxylated pentaerythritol tetramethacrylate (PETTMA), SR604 polypropylene glycol monomethacrylate (PPGMA), SR834 tricyclodecanedimethanol dimethacrylate (TCDDMDMA), and SR9054 acidic difunctional adhesion promoter.

Sartomer-manufactured acrylate-type coagents, such as: SR238 1,6-hexanediol diacrylate (HDDA), SR259 polyethylene glycol (200) diacrylate (PEG200DA), SR268G tetraethylene glycol diacrylate (TTEGDA), SR272 triethylene glycol diacrylate (TIEGDA), SR295 pentaerythritol tetraacrylate (PETTA), SR306 tripropylene glycol diacrylate (TPGDA), SR307 polybutadiene diacrylate (PBDDA), SR341 3-methyl 1,5-pentanediol diacrylate (MPDA), SR344 polyethylene glycol (400) diacrylate (PEG400DA), SR345 high performance high functional monomer, SR349 ethoxylated 3 bisphenol A diacrylate (BPA3EODA), SR351 trimethylolpropane triacrylate (TMPTA), SR355 di-trimethylolpropane tetraacrylate (Di TMPTTA), SR368 tris (2-hydroxyethyl) isocyanurate triacrylate (THEICTA), SR399 dipentaerythritol pentaacrylate (Di PEPA), SR415 ethoxylated (20) trimethylolpropane triacrylate (TMP2OEOTA), SR444 modified pentaerythritol triacrylate, SR444D pentaerythritol triacrylate (PETIA), SR454 ethoxylated 3 trimethylolpropane triacrylate (TMP3EOTA), SR492 propoxylated 3 trimethylolpropane triacrylate (TMP3POTA), SR494 ethoxylated 4 pentaerythritol tetraacrylate (PETTA), SR499 ethoxylated 6 trimethylolpropane triacrylate is (TMP6EOTA), SR502 ethoxylated 9 trimethylolpropane triacrylate (TMP9EOTA), SR508 dipropylene glycol diacrylate (DPGDA), Saret® SR522D dry liquid concentrate of cyclic-alkane diacrylate, SR534D multifunctional acrylate ester, SR595 1,10 decanediol diacrylate (DDDA), SR601E ethoxylated 4 bisphenol A diacrylate (BPA4EODA), SR602 ethoxylated 10 bisphenol A diacrylate (BPA10EODA), SR606A esterdiol diacrylate (EDDA), SR610 polyethylene glycol 600 diacrylate (PEG600DA), SR802 alkoxylated diacrylate, SR833 S tricyclodecanedimethanol diacrylate (TCDDMDA), SR9003 propoxylated 2 neopentyl glycol diacrylate (PONPGDA), SR9020 propoxylated 3 glyceryl triacrylate (GPTA), SR9035 ethoxylated 15 trimethylolpropane triacrylate (TMP15EOTA), and SR9046 ethoxylated 12 glyceryl triacrylate (G12EOTA). Sartomer-manufactured Special Scorch Protected Type Coagents, such as:

Saret® 297F Liquid Scorch protected methacrylate, Saret® 350S Liquid Scorch protected methacrylate, Saret® 350W Liquid Scorch protected methacrylate, Saret® 500 Liquid Scorch protected methacrylate, Saret® 517R trimethylolpropane triacrylate Liquid Scorch protected methacrylate, Saret® 521 diethylene glycol dimethacrylate (a liquid scorch protected methacrylate) and Saret® PRO13769;

Allylic-type coagents, such as: SR507A triallyl cyanurate (TAC), SR533 triallyl isocyanurate (TAIC), triallylphosphate (TAP), triallyl borate (TAB), trimethallyl isocyanurate (TMAIC), diallylterephthalate (DATP) aka diallyl phthalate, diallyl carbonate, diallyl maleate, diallyl fumarate, diallyl phosphite, trimethylolpropane diallyl ether, poly(diallyl isophthalate), and glyoxal bis(diallyl acetal) (1,1,2,2-Tetraallyloxyethane).

Hybrid-type coagents, such as: allyl methacrylate, allyl acrylate, allyl methacrylate oligomer, allyl acrylate oligomer, and Sartomer SR523: dual functional coagent (an allyl methacrylate or acrylate derivative); 2,4-diphenyl-4-methyl-1-pentene, also known as Nofmer® MSD (alpha-methylstyrene dimer) (available from Nippon Oil & Fat Co. particularly for wire and cable applications); and miscellaneous other crosslinking coagents, such as:

N,N′-m-phenylenedimaleimide, also known as HVA-2 (available from DuPont),

N,N′-p-phenylenedimaleimide, Cis-1,2-polybutadiene (1,2-BR),

divinylbenzene (DVB), and 4,4′-(bismaleimide) diphenyl disulphide.

Non-limiting examples of optional inert fillers for use in the organic peroxide formulations of the present invention include water washed clay, e.g., Burgess Clay, precipitated silica, precipitated calcium carbonate, synthetic calcium silicate, and combinations thereof. is Various combinations of these fillers can be used by one skilled in the art to achieve a free-flowing, non-caking final peroxide formulation.

According to some embodiments, the organic peroxide formulations of the present invention may further include at least one natural or naturally derivable scorch retardant additive. Some natural or naturally derivable scorch retardant additives such as the Vitamin K family of compounds, may be capable of acting as both a scorch retarder and as the bio-based reactive additive. The term, “natural”, as used herein means a compound that may be found in nature. The term “natural” also covers compounds that are found in nature, but subsequently purified, chemically altered, e.g. derivatized or processed in some way. The terms, “naturally derived from” or “naturally derivable” mean that such compounds may be a chemically produced equivalent of such compounds that may be found in nature to provide the equivalent scorch retardant additive. The term, “extractable” in reference to certain compounds does not mean that the compound was, in fact extracted from the source recited (usually a plant), but that the compound exists naturally in such a plant, but the compound could have been produced synthetically.

In certain embodiments, the at least one natural or naturally derivable scorch retardant additive is extractable from at least one of the group consisting of kale, collard greens, spinach, rhubarb, Chinese rhubarb, lichen, aloe vera, olive tree leaves, wintergreen, nigella sativa L. seeds or oil, henna plant leaves, red clover, alfalfa, cinchona tree bark, echinacea roots, thyme or cannabis. In certain embodiments, the at least one natural or naturally derivable scorch retardant additive may comprise at least one amino acid.

In some embodiments, the at least one natural or naturally derivable scorch retardant additive may be selected from the group consisting of Vitamin K1 (phytonadione or phylloquinone), Vitamin K2 (menaquinone), Vitamin K3 (menadione),Vitamin K2 MK-4 (menatetrenone), Vitamin K2 MK-7(menaquinone-7), Vitamin K2 MK-14 (menaquinone 14), Vitamin K2 menatetrenone epoxide, emodin (6-methyl-1,3,8-trihydroxyanthraquinone), parietin or physcion (1,8-dihydroxy-3-methoxy-6-methyl-anthracene-9,10-dione), rhein (4,5-dihydroxy-9,10-dioxoanthracene-2-carboxylic acid), aloe-emodin (1,8-dihydroxy-3-(hydroxymethyl)anthraquinone), chrysophanol (1,8-dihydroxy-3-methyl-9,10-anthraquinone), chimaphilin (2,7-dimethyl-1,4-naphthoquinone), thymoquinone, dithymoquinone, thymolhydroquinone, 2-hydroxy-2,4-napthoquinone, caffeoquinone (caffeic acid quinone), is chlorogenic acid quinone, olive leaf oil (oleuropein), quinine, caffeic acid, chlorogenic acid, cannabidiol, thymol (also known as 2-isopropyl-5-methylphenol, IPMP), cysteine, homocysteine, methionine, taurine, N-formyl methionine, and mixtures thereof.

In some embodiments, the at least one natural or naturally derivable scorch retardant additive may be preferably selected from the group consisting of Vitamin K and derivatives thereof, such as Vitamin K1 (phytonadione or phylloquinone), Vitamin K2 (menaquinone), Vitamin K3 (menadione) ,Vitamin K2 MK-4 (menatetrenone), Vitamin K2 MK-7(menaquinone-7), Vitamin K2 MK-14 (menaquinone 14), Vitamin K2 menatetrenone epoxide, and mixtures thereof.

According to certain embodiments, the weight percent of these scorch protective additives in the organic peroxide (pure bases for calculations) formulation may be: 35 wt % or less of the scorch protective additive added to a pure peroxide; preferably 20 wt % or less, more preferably 15 wt % or less, more preferably 10 wt % or less, preferably 8 wt % or less depending upon the need for scorch protection.

A non-limiting embodiment of an organic peroxide formulation is a blend of 2,5-di-methyl-2,5-di(t-butyperoxy)hexane; pentaerythritol triacrylate; and Vitamin K3 and/or oleuropein.

A non-limiting embodiment for an organic peroxide formulation is a blend of 3,6,9, triethyl-3,6,9-trimethyl-1,4,7-triperoxynonane (or methyl ethyl ketone peroxide cyclic trimer) or Trigonox® 301 from Nouryon; arginine; trimethylolpropane triacrylate; [olive leaf oil (oleuropein) and/or; cannabidiol (CBD)].

A non-limiting embodiment for an organic peroxide formulation is a blend of di-t-butylperoxide; tung oil; thymol and/or vitamin K3; and cyclic alkane diacrylate.

A non-limiting embodiment for an organic peroxide composition is a blend of t-butylperoxyisopropenylcumylperoxide; polybutadiene diacrylate; and Vitamin K2 menatetrenone epoxide

A non-limiting embodiment for an organic peroxide formulation is a blend of t-butylperoxy maleic acid; diethylene glycol dimethacrylate; and thymoquinone.

A non-limiting embodiment for an organic peroxide composition is a blend of m/p-di(t-butylperoxy)diisopropyl benzene; propoxylated 3 trimethylolpropane triacrylate; and 2-hydroxy-2,4-naphtoquinone. is A non-limiting embodiment for an organic peroxide composition is a blend of t-butylcumylperoxide; pentaerythritol trimethacrylate; thymoquinone; and lysine.

A non-limiting embodiment for an organic peroxide composition is a blend of 2,5-dimethyl-2, 5-di(t-butylperoxy) hexane; pentaerythritol trimethacrylate; and oleuropein.

Methods of Producing the Modified Bio-based Polymers:

A method of modifying a bio-based polymer and/or a biodegradable polymer comprising, consisting of or consisting essentially of: i) a step of combining: at least one organic peroxide; at least one reactive bio-based additive; and at least one bio-based polymer and/or biodegradably polymer, to form a reaction mixture; and ii) a step of reacting the reaction mixture to form a modified bio-based polymer and/or modified biodegradable polymer.

The at least one organic peroxide may be selected from those as recited above or mixtures thereof. The at least one bio-based reactive additives may be selected from those recited above or combinations thereof. The at least one bio-based polymer, biodegradable polymer, or mixtures thereof may be selected from those recited above.

The combining step may be melt blending, for example, in single-screw extrusion, twin-screw extrusion, ZSK mixer, Banbury mixer, Buss kneader, two-roll mill, or impeller mixing, or other type of suitable polymer melt blending equipment to produce the reaction mixture. The combining step may be a part of process to produce finished article, for example a blown film process, a cast film process, injection molding, injection blow molding, thermoforming, or vacuum forming for example.

Formation of the reaction mixture by combining the components is not limited to a single step. For example, the at least one organic peroxide and the at least one bio-based reactive additive may be combined and mixed together to form a formulation for producing a modified bio-based polymer and/or modified biodegradable polymer. The formulation for producing a modified bio-based polymer may then be combined with the bio-based polymer to form the reaction mixture. The combining steps may be performed in any order. In alternative embodiments, the bio-based polymer and/or biodegradable polymer may first be blended or combined with the reactive bio-based additive to form a formulation of the bio-based polymer is and/or biodegradable polymer and the bio-based reactive additive. In a subsequent step this formulation may be blended or combined with the peroxide, subjected to suitable reaction conditions (either during or after the combining step) to form the modified bio-based polymer and/or modified biodegradable polymer. In yet another alternative embodiment, the bio-based polymer and/or biodegradable polymer, and organic peroxide may be combined or blended to form a bio-based and/or biodegradable polymer-organic peroxide formulation. In a subsequent step the bio-based and/or biodegradable polymer-organic peroxide formulation may be combined with the bio-based reactive additive and subjected to suitable reaction conditions to form the modified bio-based polymer and/or modified biodegradable polymer. The combining and reacting step may be effected at the same time.

The step of reacting the reaction mixture may comprise, consist of, or consist essentially of, a step of heating the reaction mixture during at least one of the combining step or steps. Suitable temperatures are for example, temperatures effective to melt the bio-based polymer and decompose the organic peroxide. For example, the reaction mixture may be heated to at least 160° C. or at least 175° C. or at least 200° C. or at least 230° C. or at least 250° C.

The combining step and/or the reacting step may include the step of extruding the reaction mixture to form the modified bio-based polymer and/or modified biodegradable polymer. The bio-based and/or biodegradable polymer, and the organic peroxide and the bio-based reactive additive may be blended to form the reaction mixture prior to extruding the reaction mixture, or may be blended to form the reaction mixture during extrusion or other melt processing step. The method may include a further step of forming the modified bio-based and/or modified biodegradable polymer into packaging (such as food packaging) or another type of film. The modified bio-based polymer and/or modified biodegradable polymer can be processed using any known polymer processing method, including but not limited to film foaming, film blowing, injection molding, extrusion, calendaring, blow molding, foaming, and thermoforming. Useful articles that can be made using the modified bio-based polymer of the present invention include but are not limited to packaging materials and films. A variety of other useful articles and processes for forming those articles can be contemplated based on the present disclosure.

The following peroxides are excluded from this invention as described herein: inorganic is peroxides (for example hydrogen peroxide), ammonium and/or potassium persulfate; hydroperoxides, and methylethylketone (MEK) type peroxides. Also excluded are: methanol; water emulsions; silicone fluids; silane coupling agents; isocyanates; maleic, succinic, phthalic, trimellitic anhydrides and acids; polyethylene glycol polymers and block polymers made from polyethylene glycol; and starch, (for example, corn starch). Any or all of these compounds may be present in the formulation for producing a modified bio-based polymer at levels of up to about 5 weight percent, up to about 4 weight percent, up to about 3 weight percent, up to about 2 weight percent, up to about 1 weight percent, up to about 0.5 weight percent, up to about 1000 ppm weight, based on the total weight of the organic peroxide, bio-based reactive additive and bio-based polymer. Preferably, none of these compounds are present in the formulation.

Standard Test Methods and Equipment Used in the Practice of this Invention

ASTM D4440-15 Standard Test Method for Plastics: Dynamic Mechanical Properties Melt Rheology; This test method requires the use of an Alpha Technologies RPA® 2000 instrument (RPA stands for Rubber Plastics Analyzer) which is essentially a dynamic mechanical analyzer.

ASTM D4440-15: Standard Test Method For Plastics: Dynamic Mechanical Properties Melt Rheology. This is the current method as of February 24, 2020.

This test method outlines the use of dynamic mechanical instrumentation in determining and reporting the rheological properties of thermoplastic resins and other types of molten polymers. It may be used as a method for determining the complex viscosity and other significant viscoelastic characteristics of such materials as a function of frequency, strain amplitude, temperature, and time. Such properties may be influenced by fillers and other additives.

It incorporates a laboratory test method for determining the relevant rheological properties of a polymer melt subjected to various oscillatory deformations on an instrument of the type commonly referred to as a mechanical or dynamic spectrometer.

This test method is intended to provide a means of determining the rheological properties of molten polymers, such as thermoplastics and thermoplastic elastomers over a range of temperatures by nonresonant, forced-vibration techniques. Plots of modulus, viscosity, and tan is delta as a function of dynamic oscillation (frequency), strain amplitude, temperature, and time are indicative of the viscoelastic properties of a molten polymer.

Rheotens instrument test: A device designed for the measurement of polymer melt strength. Measures the tensile force needed for elongation of a polymer melt, measured as a function of draw ratio.

The commercial importance and novelty of this invention will be further evident to those developing various medical and indirect food contact consumer products and packaging based on poly(lactic acid).

Various non-limiting aspects of the invention are summarized as follows:

### EXAMPLES

### Example 1 (Prophetic)

Masterbatches (MB1 to MB32) containing various ingredients are prepared using a low shear, Marion® ribbon blender. The following masterbatches are created in the ribbon blender are melt blended and reacted with poly(lactic acid) using a Werner & Pfleiderer co-rotating twin screw extruder as described in Example 2.

Masterbatch 1 (MB1): 60 kilograms Hi-Siler ABS silica (PPG Industries); 35 kilograms tung oil; 4.75 kilograms t-butylperoxy-isopropenylcumylperoxide; and 0.25 kilograms of Vitamin K3.

Masterbatch 2 (MB2): 60 kilograms HiSil ABS silica; 30 kilograms oiticica oil; 9.75 kilograms Luperox® 101SIL; and 0.25 kilograms of vitamin K2.

Masterbatch 3 (MB3): 30 kilograms Hi-Siler ABS silica; 20 kilograms precipitated calcium carbonate; 10 kilograms cellulose acetate butyrate (“CAB”, Eastman Chemical); 10 kilograms arginine; 10 kilograms oleylamine; 10 kilograms pentadecyl amine; 1 kilogram zinc oxide; and 9 kilograms Trigonox® 301 (Nouryon).

Masterbatch 4 (MB4): 60 kilograms Hi-Siler ABS silica; 29 kilograms limonene; 10.5 kilograms Vul-Cup® 40KE; and 0.5 kilogram vitamin K1.

Masterbatch 5 (MB5): 60 kilograms Hi-Siler ABS silica; 10 kilograms lysine; 10 is kilograms cysteine; 10 kilograms itaconic anhydride; 1 kilogram vitamin K3; and 9 kilograms Luperox® 231XL40.

PLA-Peroxide Masterbatch 6 (MB6): 95 kilograms poly(lactic acid) pellets or powder; 5 kilograms 1-methoxy-l-t-amylperoxy cyclohexane. The liquid peroxide Luperox® V10 (a hemi-peroxyketal peroxide) is sprayed on the PLA powder or pellets to create a peroxide masterbatch.

PLA-Peroxide Masterbatch 7 (MB7): 95 kilograms poly(lactic acid) pellets or powder; 5 kilograms Luperox® JWEB®50 (Arkema). This is the tetra functional peroxide liquid sprayed on the PLA powder or pellets to create a peroxide masterbatch.

PLA-Peroxide Masterbatch 8 (MB8): 95 kilograms poly(lactic acid) pellets or powder; 5 kilograms t-butyperoxy-isopropenylcumylperoxide liquid peroxide are sprayed on the PLA powder or pellets to create the peroxide masterbatch. This is the monomeric functionalized peroxide.

Masterbatch 9 (MB9): 60 kilograms Hi-Siler ABS; 10 kilograms calcium silicate; 20 kilograms arginine; 8 kilograms Vul-Cup® 40KE (Arkema); 0.4 kilograms mercaptobenzothiazole disulfide (MBTS); and 1.6 kilograms Vultac® 5 (MLPC Arkema).

Masterbatch 10 (MB10): 60 kilograms Hi-Siler ABS; 10 kilo_{g}rams calcium silicate; 20 kilograms itaconic acid; 8 kilograms Luperox® 101XL45 (Arkema); 0.5 kilograms mercaptobenzothiazole disulfide (MBTS); and 1.6 kilograms zinc dithiophosphate (ZDDP).

Masterbatch 11 (MB11): 74.5 kilograms Hi-Siler ABS silica; 10 kilograms limonene; 10 kilograms lecithin; 5 kilograms Trigonox® 301 (Nouryon); and 0.5 kilograms oleuropein (olive leaf oil).

Masterbatch 12 (MB12): 74.5 kilograms Hi-Siler ABS silica; 10 kilograms limonene; 10 kilograms lecithin; 5 kilograms 2,5-dimethyl-2,5-di(t-butylperoxy)hexyne-3; and 0.5 kilograms oleuropein (olive leaf oil).

### Example 2 (Prophetic)

Masterbatches (MB1 to MB12) are prepared in Example 1 using a low shear, Marion® ribbon blender. These masterbatches are then melt blended and reacted with poly(lactic acid) using a Werner & Pfleiderer co-rotating twin screw extruder. The extruder has 8 barrel segments and 5 heating zones. Temperature settings are chosen to melt the PLA and fully react the additives.

Use levels (phr) for the various masterbatches of Example 1: The masterbatch MB3 is used at 2, 4, 6, 8 and 10 phr, where phr is parts by weight of masterbatch per 100 parts by weight of poly(lactic acid). The other remaining masterbatches of Example 1 are used at 4, 6, 8, 10, 12, 14, 16, 18 and 20 phr.

The following masterbatches are created in Example 1: MBS; MB6 and MB7 are melt reacted at using the extruder barrel settings of 160° C., 160° C., 170° C., 170° C., 180° C. The remaining masterbatches use the temperature settings of 160° C., 170° C., 180° C., 190° C., 200° C. for the five individual zones, wherein 160° C. zone is closest to the hopper and 200° C. is at the exit die.

### Example 3 (Prophetic)

The modified PLA resins from Example 2 are then melt blended polyethylene, polypropylene, and polyamide using the twin screw extruder. The temperature settings are 160° C., 170° C., 180° C., 190° C., 200° C. for the five individual zones. Tensile bars are molded.

### Examples 4-15

In the following Examples, the PLA polymer grade used was Ingeo™ Biopolymer 2003D (NatureWorks). Ingeo™ biopolymer 2003D is a transparent, high molecular weight extrusion grade biopolymer suitable for use in dairy containers, food service ware, transparent food containers, hinged-ware and cold drink cups. The PBAT polymer used was Ecoflex® (BASF). Ecoflex® polymer is a biodegradable and compostable polymer made from fossil fuel products, which can be blended with bio-based polymers.

No care was taken to pre-dry or remove moisture from the PLA or PBAT polymer prior to modification even though these polymers were stored in open storage bins.

To study the modification of the bio-based and biodegradable polymers of this invention, we used a RPA® 2000 rheometer (Alpha Technologies). Depending upon the half-life of the is peroxide used, the polymer compositions were tested on the RPA® 2000 rheometer at either 170° C. or 180° C. using a 1° arc strain and 100 cpm (cycles per minute) frequency where the Elastic Modulus S′ was measured in dN-m. The elastic modulus is a type of shear modulus, which follows changes to the modified polymer melt. Elastic modulus is directly proportional mathematically to the Young's tensile modulus. A higher elastic modulus in dN-m for the modified polymer melt means a greater (higher) polymer melt strength.

### Example 4

A peroxide blend comprising 33.4 wt % Luperox® DTA (di-t-amyl peroxide) and 66.6 wt % TAIC (triallyl isocyanurate) was used at 1.0 wt % to modify the PLA bio-based polymer at 180 ° C. and evaluated using the RPA®2000 rheometer to study the increase in elastic modulus.

A second peroxide blend comprising 33.36 wt % Luperox® DTA (di-t-amyl peroxide), 66.55 wt % TAIC (triallyl isocyanurate) and 0.08 wt % (vitamin K1 and vitamin K2) was made and used at 1.3 wt % in the PLA. The (vitamin K1 and vitamin K2) blend used has the following composition: Vitamin K1 as phytonadione at 1500 mcg, Vitamin K2 as Menaquinone-4 at 1000 mcg and Vitamin K2 as trans Menaquinone-7 at 100 mcg.

A third peroxide blend was made comprising 32.1 wt % Luperox® DTA (di-t-amyl peroxide), 64 wt % TAIC (triallyl isocyanurate) and 3.9 wt % vitamin K3; which was then added to the PLA at a 2.0 wt % concentration.

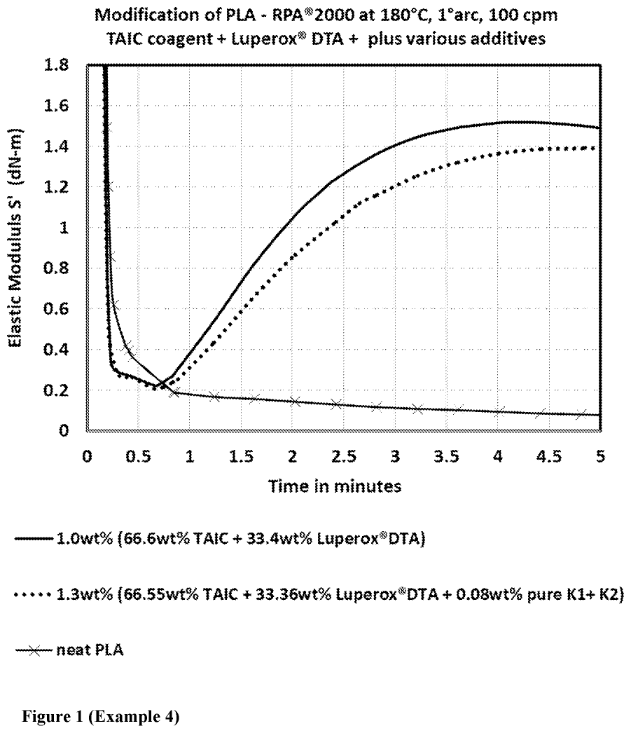

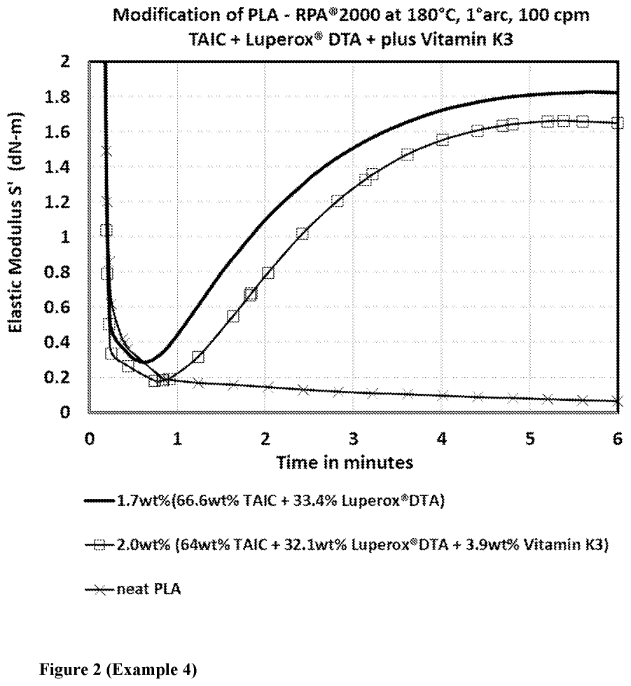

The rheographs of FIGS. 1 and 2 show the increase in elastic modulus (dN-m) when neat PLA is reacted with the Luperox® DTA peroxide and TAIC coagent blend. FIGS. 1 and 2 also show the benefits of using Vitamin K (K1, K2 or K3) in combination with the Luperox® DTA and coagent TAIC blend. These vitamins provided a desirable delay (act as scorch retarders) in the modification process of the PLA melt strength or elastic modulus. When melt mixing organic peroxides or blends of organic peroxides with compounds that contain reactive multiple carbon-carbon double bonds of allylic, maleimide, methacrylic or acrylic functionality in an extruder, it is important to have good melt mixing of these reactive components in the PLA or PBAT polymer before actual modification occurs. A delay in the modification process of even a few seconds at elevated extruder temperatures can be beneficial to increase the incorporation of the reactive components into the polymer melt, prior to the desired polymer modification reaction. This desirable short delay in the polymer modification reaction provides a more uniformly modified polymer. Improved incorporation of the reactive additives avoids the situation where a non-uniform blending of additives in the polymer creates either too much or too little modification of the polymer (or a combination of both) during continuous extrusion.

Luperox® DTA (also known as di-t-amyl peroxide) does not generate any t-butyl alcohol, which may be a desired attribute for the final modified polymer. FIGS. 1 and 2 show that it is possible to delay the onset of PLA modification using a vitamin K type additive. In FIG. 2, when using vitamin K3 not only is there a delay, but it is possible to approach the unmodified elastic modulus of the neat PLA (initially) for better mixing of the bio-polymer. The line with the square marker initially approaches the neat PLA performance versus the peroxide and coagent without the vitamin K additive. The peroxide formulation containing Vitamin K3 shown in FIG. 2 momentarily performs like there is no reactive species (the short delay prior to modification which initially overlays the curve of the neat PLA), followed by a significant increase in the elastic modulus.

The amount of peroxide formulation used can be adjusted lower or higher to attain the desired amount of PLA melt strength modification. So if a small amount of modification is desired, a smaller amount of peroxide, plus coagent and vitamin K may be used. Such peroxide loading adjustments can be made depending upon the desired physical property performance and specific end-use application (film, coating, fiber, foam, etc.).

### Example 5

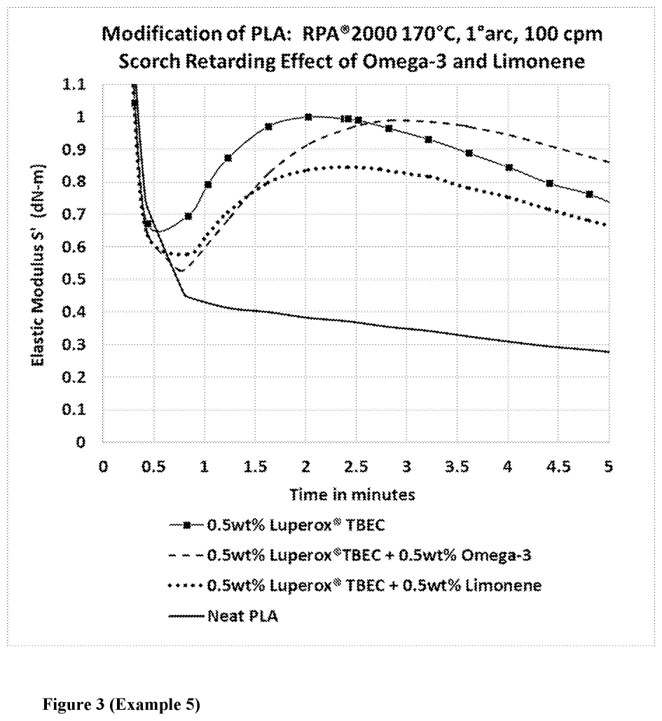

FIG. 3 depicts a Rheograph generated at 170° C. and shows the delay in the improvement in the elastic modulus (higher melt strength) achieved with select additives used in the practice of this invention in combination with an organic peroxide. Luperox® TBEC (a 95 wt % assay peroxide also known as t-butylperoxy-2-ethylhexylmonoperoxycarbonate) was added to PLA (Ingeo™ Biopolymer 2003D) at a concentration of 0.5 wt %. When reacted with molten PLA at 170 ° C. in the RPA® 2000 rheometer, the use of 0.5 wt % Luperox® TBEC increased the elastic modulus (PLA melt strength) versus the neat PLA without any other additives. The separate additions of Omega 3 (fish oil) at 0.5 wt % to PLA along with 0.5 wt % Luperox® TBEC; and 0.5 is wt % Limonene (oil of citrus fruit peels) added to PLA along with 0.5 wt % Luperox® TBEC favorably delayed the PLA modification reaction. The delays provided by the Omega 3 and Limonene bio-based reactive additives of this invention provided for a more controlled melt modification of the biopolymer PLA in a melt blending/extrusion process. FIG. 3 shows that the use of these additives provided the benefit of a ˜30 second delay in the peroxide modification reaction to better facilitate many mixing turns of a twin screw extruder for better incorporation of the reactive peroxide into the PLA melt, prior to the peroxide reaction and modification of the PLA Elastic Modulus or melt strength. Thus the use of these bio-based reactive additives Omega 3 and Limonene provided a more controlled modification of the PLA when used in combination with the organic peroxide Luperox® TBEC.

### Example 6

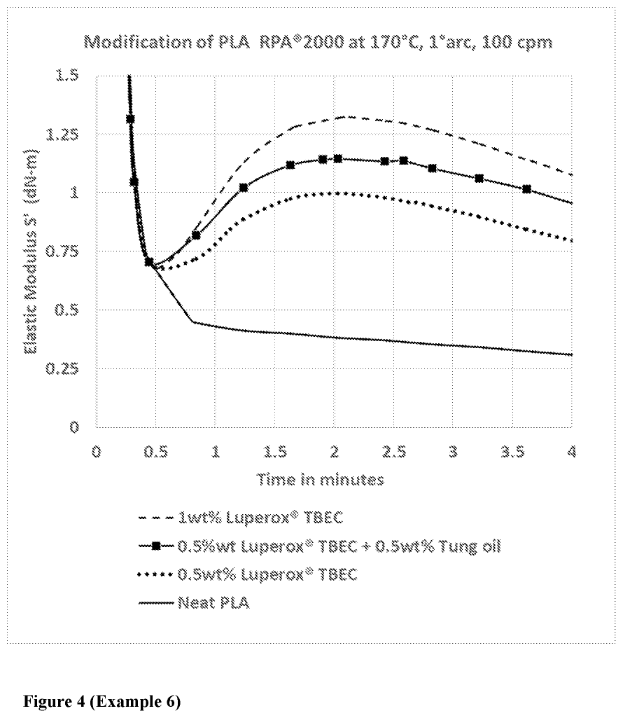

This provides an example of the unexpected benefit of using tung oil to modify PLA with organic peroxides. Tung oil is a naturally derived oil. The rheograph of FIG. 4 shows 0.5 wt % tung oil in combination with 0.5 wt % Luperox® TBEC, reacted with PLA (Ingeo™ Biopolymer 2003D) in the RPA® 2000 at 170° C. When the tung oil was used in an equal weight ratio to the peroxide, a significant increase in the PLA melt strength resulted, as indicated by the increase in the elastic modulus in dN-m versus the use of 0.5 wt % Luperox® TBEC without the use of tung oil.

Tung oil unexpectedly provided enhanced melt strength of PLA (higher elastic modulus) while minimizing the amount of peroxide required. Based on these results, one can see that the modification attained with tung oil is mid-way between the results obtained for 0.5 wt % Luperox® TBEC to those using 1.0 wt % Luperox® TBEC. In this case, tung oil can unexpectedly be used to replace about 0.25 wt % of the peroxide. The solid line without any markers is the neat (virgin) PLA with no additives. Luperox® TBEC is a 95 wt % assay peroxide also known as OO-t-butylperoxy-2-ethylhexylmonoperoxycarbonate.

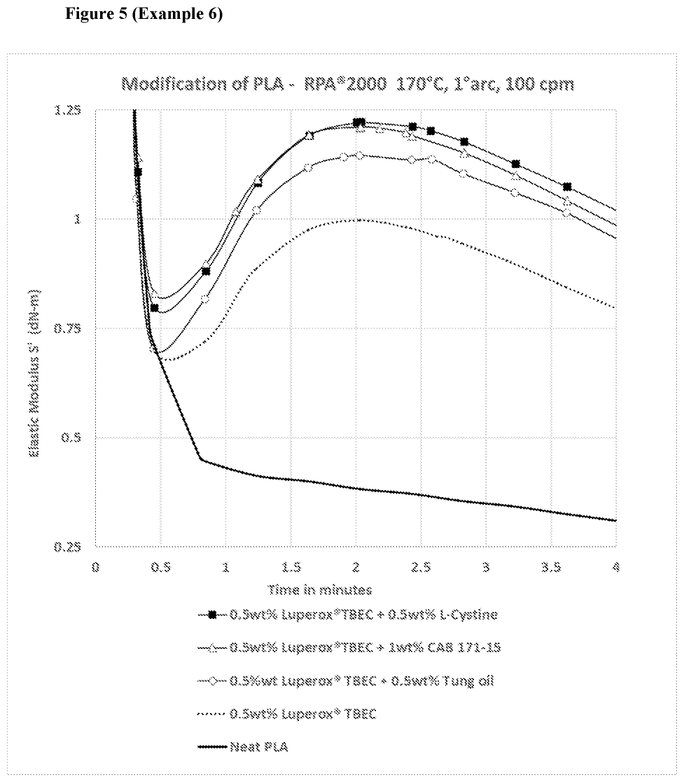

In a similar fashion, FIG. 5 shows the unexpected advantages of using L-Cystine (an amino acid) and CAB (cellulose acetate butyrate) when using 0.5 wt % Luperox® TBEC (a 95 wt % assay peroxide also known as t-butylperoxy-2-ethylhexylmonoperoxycarbonate). Surprisingly, when 0.5 wt % of L-Cystine was added to PLA along with 0.5 wt % Luperox® TBEC, an unexpected increase in the elastic modulus (increase in melt strength) of the PLA was is obtained compared to the singular use of 0.5 wt % Luperox® TBEC.

Furthermore, 1 wt % CAB 171-15 (cellulose acetate butyrate, Eastman Chemical) added to the PLA along with 0.5 wt % Luperox® TBEC, provided an unexpected increase in the elastic modulus when reacted at 170° C. versus the elastic modulus obtained when using 0.5 wt % Luperox® TBEC organic peroxide alone, without any additives. This discovery provides a way to make an extended peroxide formulation using CAB powder that can increase the PLA melt strength in a more efficient manner. Luperox® TBEC is a liquid organic peroxide at room temperature. Depending upon the available metering equipment in the plant, a peroxide formulation in a solid form may be desired; however, in other cases a liquid peroxide form may be desired. If a liquid peroxide formulation is desired, a blend of Luperox® TBEC and tung oil can be used at a 50:50 wt % ratio to more efficiently increase the PLA elastic modulus (melt strength) as shown with the combination of 0.5 wt % Luperox® TBEC and 0.5 wt % tung oil, provided in FIG. 5.

### Example 7

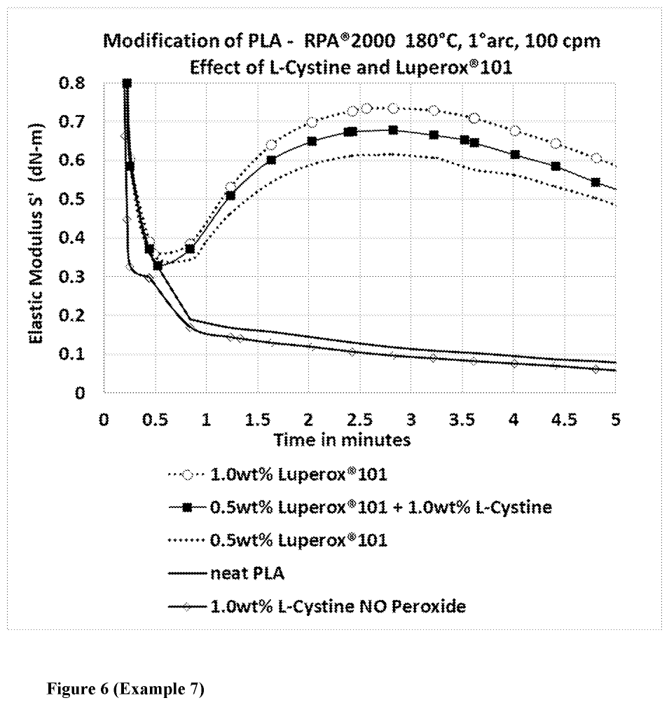

The rheograph data in FIG. 6 illustrates the effectiveness of the amino acid L-Cystine and its unexpected ability to increase the elastic modulus of PLA when used in combination with an organic peroxide. 0.5 wt % Luperox®101 (also known as 2,5-dimethyl-2,5-di(t-butylperoxy)hexane) was added to PLA, with or without 1.0 wt % L-Cystine. The use of the amino acid L-Cystine contributed to an unexpected increase in the elastic modulus, which correlates to an increase in PLA melt strength. The use of 1.0 wt % L-Cystine with no peroxide did not provide any increase in the PLA elastic modulus (dN-m) as can be seen in FIG. 6. This is further proof of the unexpected synergy obtained when using our reactive additives in combination with select organic peroxides, as per the practice of our invention.

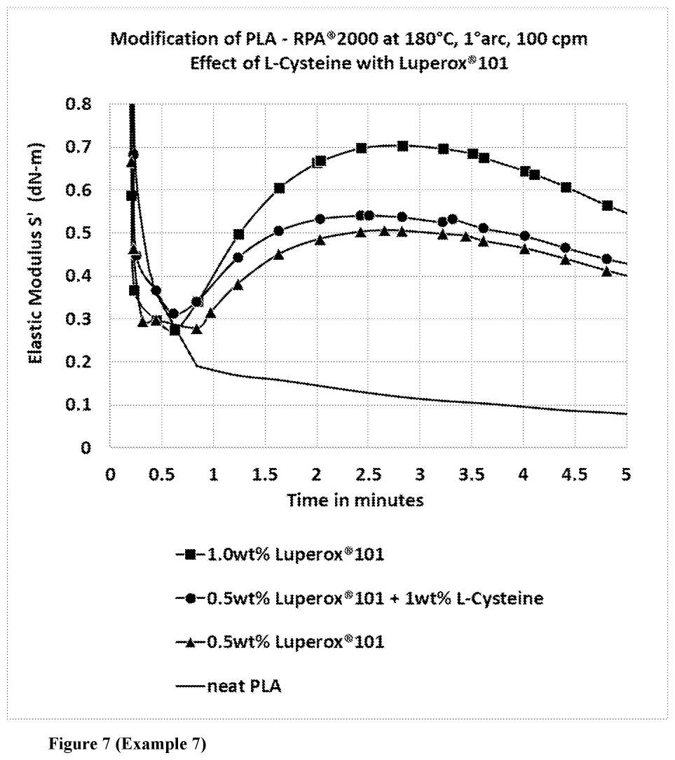

The rheograph data in FIG. 7 illustrates the use of another amino acid L-Cysteine to increase the melt strength of PLA. It was unexpectedly found that the amino acid L-Cysteine when used at 1.0 wt % in PLA along with 0.5 wt % Luperox® 101 provided an increase in the elastic modulus of PLA at 180° C., compared to the singular use of 0.5 wt % Luperox®101, as shown in the rheograph results of FIG. 7.

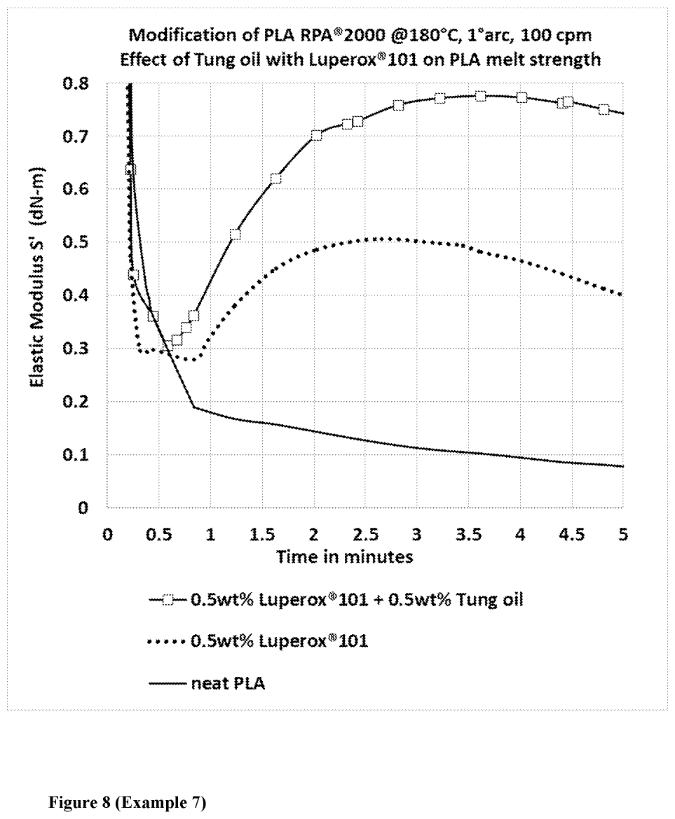

FIG. 8 (Example 7) provides more data showing the effectiveness of tung oil to increase the PLA elastic modulus (melt strength) when used with a different organic peroxide, Luperox® 101, and reacted with PLA at 180° C. Tung oil continues to unexpectedly provide an effective means to further increase the melt strength of the bio-based polymer PLA when used in combination an organic peroxide. In the rheograph of FIG. 8, 0.5 wt % Luperox®101 (2,5-dimethyl-2,5-di(t-butylperoxy)hexane) is used with and without 0.5 wt % tung oil at 180° C. in PLA. This combination of peroxide and tung oil, provided a greater elastic modulus versus the use of 0.5 wt % Luperox® 101 alone. The neat PLA with no peroxide or additives helps to show the comparative improvement in melt strength.

### Example 8

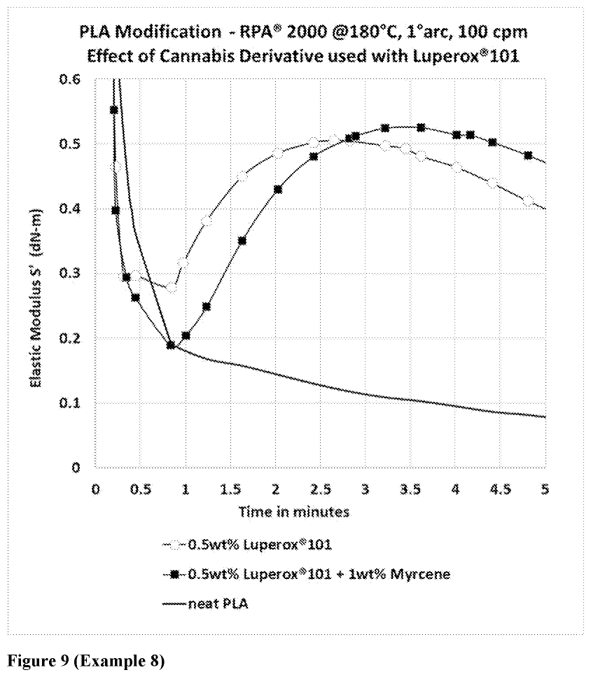

A liquid peroxide composition comprising a 1:2 wt ratio of Luperox® 101 to myrcene was prepared. That is, 0.5 part Luperox® 101 was blended with 1.0 part of myrcene on a weight basis to form a liquid peroxide composition, as both compounds are liquid at room temperature. Please refer to FIG. 9. This liquid peroxide composition was added to PLA at 1.5 wt %, such that 0.5 wt % Luperox® 101 was added to PLA along with 1 wt % of myrcene in PLA. Myrcene is a natural terpene found in cannabis and other plant species. The PLA used was Ingeo™ Biopolymer 2003D, as before.

Referring to FIG. 9 (Example 8), unexpectedly we found that the use of myrcene in combination with the Luperox® 101 organic peroxide provided a significant delay in the PLA modification at 180° C. as compared to 0.5 wt % Luperox® 101 used alone in the PLA.

The rheograph data in FIG. 9 shows a significant delay in the modification of PLA at 180° C. to allow for more uniform melt blending of reactive components at 180° C. prior to completing the reaction in an extruder or melt mixer for example. This blend of peroxide and myrcene for modifying PLA provided a desirable increase in melt strength (increased elastic modulus in dN-m) versus the use of peroxide alone while providing a significant delay in the modification to facilitate melt mixing. This novel liquid peroxide composition provided an initial elastic modulus that closely resembled the performance the neat PLA with no peroxide for the first ˜45-50 seconds, providing the desired delay in the PLA modification for improved melt mixing which was then followed by a desirable increase in the PLA melt strength as evidenced is by the increase in the measured elastic modulus S′ (dN-m).

### Example 9

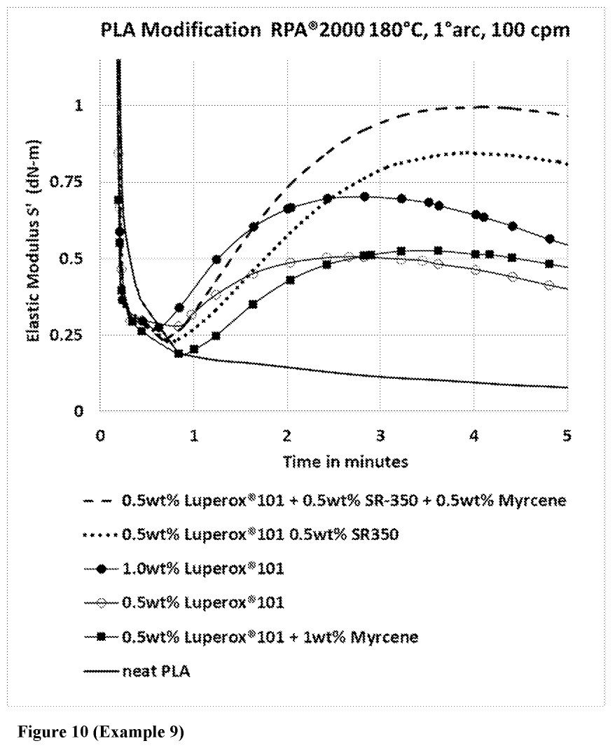

In this Example, we show the benefits of using Myrcene in combination with a coagent and an organic peroxide for the modification of PLA. Referring to FIG. 10, PLA was modified with a blend of 0.5 wt % Myrcene, 0.5 wt % SR350 coagent (trimethylolpropane trimethacrylate from Sartomer) and 0.5 wt % Luperox® 101 organic peroxide. Myrcene unexpectedly increased the elastic modulus of the PLA above that obtained when just using 0.5 wt % SR350 with 0.5 wt % Luperox® 101 organic peroxide. The blend of Myrcene, SR350 coagent and Luperox® 101 peroxide provided a higher elastic modulus than using 1 wt % Luperox® 101 peroxide alone with no other additives. Yet despite the fact that Myrcene provided the highest elastic modulus when blended with Luperox® 101 and SR350, it also provided a delay in the modification when compared to the singular use of 1 wt % Luperox® 101 peroxide. So in summary, the natural terpene Myrcene provided a further increase the PLA melt strength (elastic modulus) while also providing a delay in the modification process compared to the singular use of higher loadings of the organic peroxide, i.e., 1.0 wt % Luperox® 101 used alone.

### Example 10

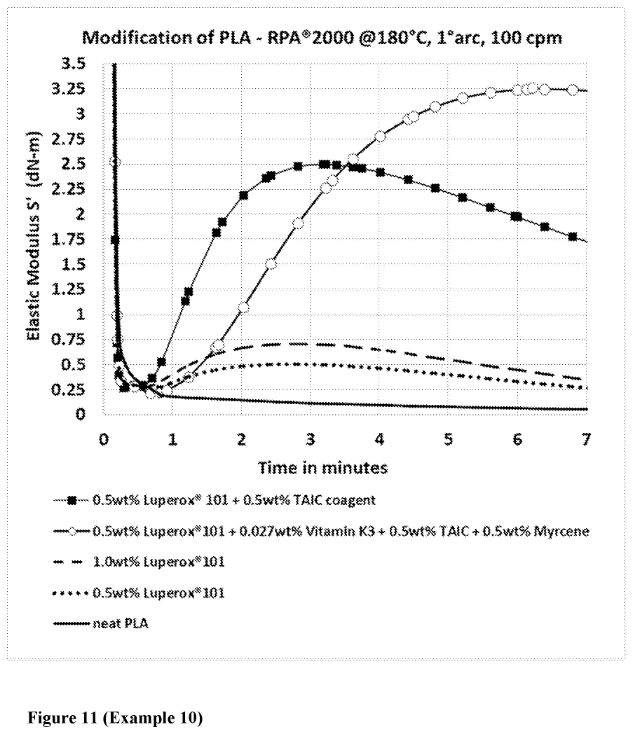

Please refer to FIG. 11 (Example 10). The elastic modulus of PLA can be increased with the use of a coagent such as TAIC. This modification of PLA occurs fairly quickly at 180 ° C. as can be seen in FIG. 11 when a combination of 0.5 wt % Luperox® 101 is used with 0.5 wt % TAIC (triallyl isocyanurate) coagent. In FIG. 11, we show how it is possible to delay this modification to increase the melt mixing time at 180° C. in an extruder for example by the use of the bio-based reactive additives of our invention. In FIG. 11, 0.5 wt % Luperox® 101, 0.027 wt % Vitamin K3, 0.5 wt % TAIC coagent and 0.5 wt % Myrcene were mixed into PLA and reacted at 180 ° C. using the RPA®2000 rheometer. This Luperox® 101 peroxide composition using Myrcene and Vitamin K3 that included the triallyl isocyanurate coagent provided a desirable delay in the modification process to allow for more melt mixing time in an extruder for example. In addition, the use of these additives also provided a modified PLA polymer that has a significantly greater Elastic Modulus (dN-m) or polymer melt strength as compared to the use of 0.5 wt % Luperox® 101 and 0.5 wt % TAIC coagent without the bio-based additives. The amount of PLA modification (or polymer melt strength) required can be optimized by one of normal skill in the art by either decreasing or increasing the amount of this novel peroxide formulation in the bio-based polymer (PLA) while also obtaining a desirable delay in the modification process to provide for better incorporation of all reactants into the polymer. This novel peroxide composition is useful for modifying the bio-based polymers and/or the biodegradable polymers taught in this invention.

### 2Example 11

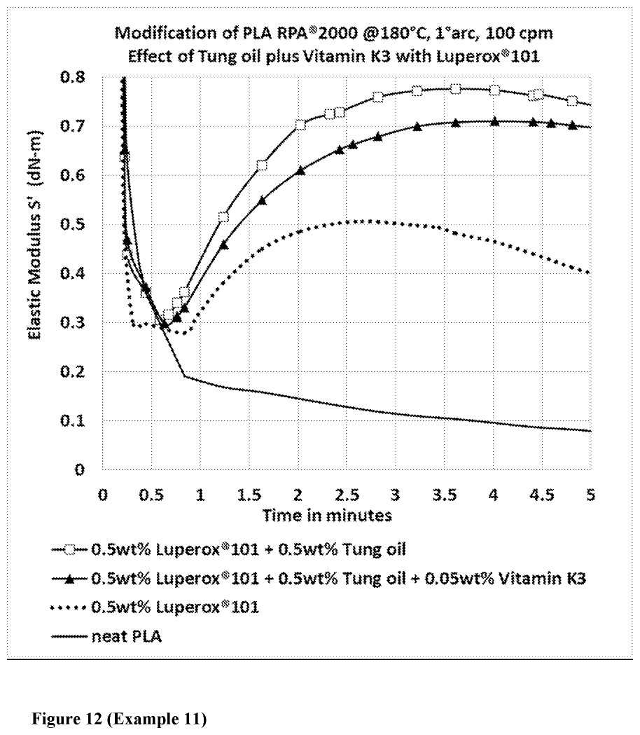

Please refer to FIG. 12 (Example 11). In this Example, 0.5 wt % Luperox®101 organic peroxide was combined with 0.5 wt % tung oil (a bio-based oil) to modify PLA, resulting in an increase in the elastic modulus for the PLA modification conducted at 180 ° C. Using this natural bio-based oil combined with Luperox®101, significantly increased the elastic modulus or melt strength of the PLA polymer. To provide a desirable delay in this process while modifying the degree of modification of PLA, 0.05 wt % Vitamin K3 was added to this peroxide & tung oil formulation, as shown in FIG. 12. In summary, a blend of Luperox®101 peroxide and tung oil, or a blend of Luperox®101 peroxide, tung oil and Vitamin K3 can be useful to modify PLA to enhance its physical properties.

### Example 12

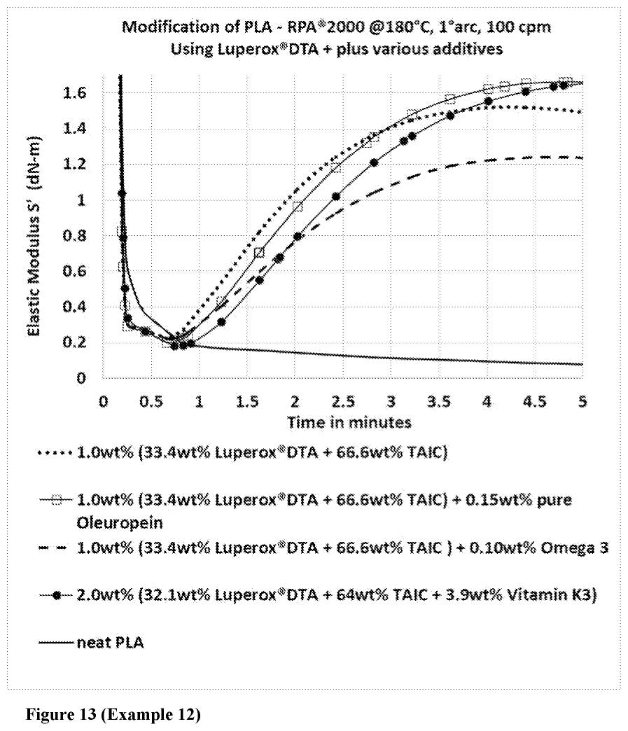

Please refer to FIG. 13 (Example 12). 1.0 wt % of a peroxide composition containing 33.4 wt % Luperox® DTA and 66.6 wt % TAIC (triallyl isocyanurate) coagent was added to PLA and reacted in the RPA rheometer at 180° C. To provide a desirable delay in the modification of s PLA, the use of different additives as taught in this invention such as oleuropein, Omega 3 and Vitamin K3 are used. Thus, 0.15 wt % pure oleuropein was added to PLA along with 1.0 wt % of a peroxide composition containing 33.4 wt % Luperox® DTA and 66.6 wt % TAIC coagent. The use of oleuropein provided a desirable delay in the modification reaction of PLA, as shown in FIG. 13. Oleuropein olive leaf extract capsules (Roex) were used in this example, which contained 20% pure oleuropein (active ingredient in olive leaf extract). So to add 0.15 wt % of pure oleuropein to the PLA, 0.75 wt % of the actual olive leaf extract from the Roex capsules had to be incorporated into the PLA resin. In another experiment, 0.10 wt % Omega 3 oil was added to PLA along with 1.0 wt % of a peroxide composition containing 33.4 wt % Luperox® DTA and 66.6 wt % TAIC coagent. Unexpectedly, a significant delay in the PLA modification was is observed. The peroxide formulation loadings taught in this invention may be readily adjusted to attain the desired amount of PLA modification. Thus for example, if a significantly longer scorch time (safe mixing time) is required with a similar modification attained with 1.0 wt % of a peroxide composition containing 33.4 wt % Luperox® DTA and 66.6 wt % TAIC coagent, it is possible when using 2 wt % of a peroxide composition containing 32.1 wt % Luperox® DTA and 64 wt % TAIC coagent and 3.9 wt % Vitamin K3. Luperox® DTA, an organic peroxide whose chemical name is di-t-amyl peroxide, does not generate t-butyl alcohol during the decomposition process when used to modify the PLA polymer melt strength.

### Example 13

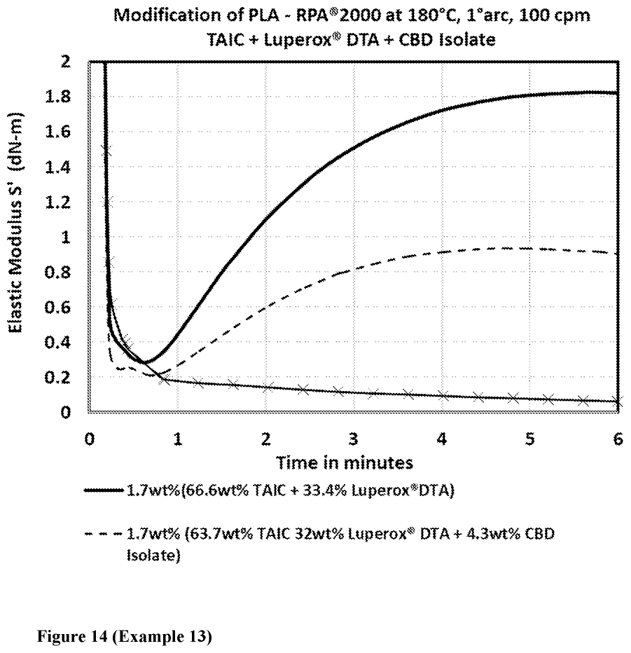

Please refer to FIG. 14 (Example 13). Cannabidiol (CBD) was used with Luperox® DTA (di-t-amyl peroxide) and TAIC (triallyl cyanurate) to modify PLA's melt strength at 180° C. Specifically, 1.7 wt % of a peroxide composition (63.7 wt % TAIC, 32 wt % Luperox® DTA and 4.3 wt % CBD Isolate) was used to modify PLA. This was compared to the use of 1.7 wt % of a peroxide composition (66.6 wt % TAIC and 33.4 wt % Luperox® DTA) in PLA. The use of CBD provided a desirable slowing down of the PLA modification process at 180° C. based on the rheograph results showing the desired delay in the increase of the elastic modulus S′(dN-m) versus time as shown in FIG. 14. One of normal skill in the art can adjust the amount of final PLA melt strength modification by adjusting the peroxide formulation concentration provided in FIG. 14. Unlike other CBD products, CBD isolate is a white solid, not an impure CBD oil and does not contain any THC tetrahydrocannabinol. In summary, CBD isolate when used as a novel additive in the practice of this invention offers a way to control both the rate and the degree of modification to the PLA polymer when using reactive peroxide and coagent combinations e.g., Luperox® DTA and TAIC (triallyl isocyanurate).

### Example 14

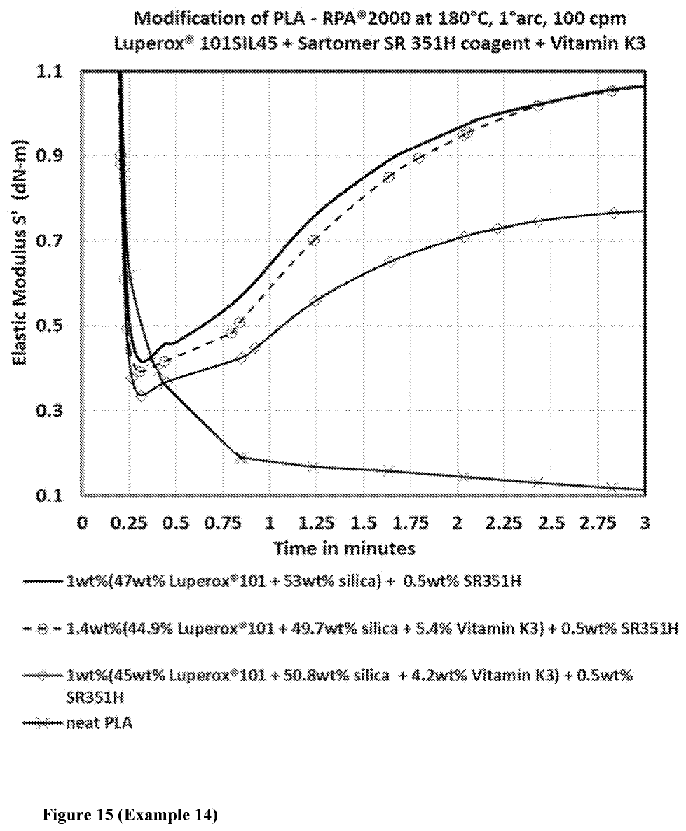

Please refer to FIG. 15 (Example 14). In some commercial processes, it may be useful to use a filler extended organic peroxide. In this example, Luperox®101SIL45 was used which had a reported 47 wt % peroxide assay on silica filler. It is a free-flowing powdered peroxide formulation. Using the powder form of a peroxide as a base, two different filler extended peroxide formulations were made by adding different amounts of powdered Vitamin K3 to this silica filler extended organic peroxide. The addition of the Vitamin K3 reduced the peroxide assay wt % in the final formulations, as the total wt % of all components must add up to 100% in the formulation. In each case, a reactive coagent was added to the PLA polymer. Sartomer SR351H (also known as “trimethylolpropane triacrylate” or “TMPTA” which is a trifunctional acrylate coagent”) was added at 0.5 wt % to the PLA.

Thus 1.0 wt % (47 wt % Luperox® 101 +53 wt % silica) and 0.5 wt % SR351H was added to PLA. Another peroxide formulation at 1.0 wt % (45 wt % Luperox® 101+50.8 wt % silica +4.2 wt % Vitamin K3), and 0.5 wt % SR351H was added to PLA. Yet another peroxide formulation at 1.4 wt % (44.9 wt % Luperox® 101 +49.7 wt % silica +5.4 wt % Vitamin K3), and 0.5 wt % SR351H was added to PLA.

The use of Luperox®101SIL45 peroxide and Sartomer SR351H is a fast reacting combination of curatives for the modification of PLA at 180° C. As shown in FIG. 15, the addition of powdered Vitamin K3 to the powder peroxide formulation resulted in a free-flowing easy to handle composition that provides the ability to slow down the initial modification reaction of the PLA bio-polymer to allow for better, more uniform melt mixing in an extruder or melt blender. FIG. 15 shows that by adjusting the amount of Vitamin K3 in the extended peroxide formulation and/or by adjusting the overall peroxide concentration added to the PLA, one can obtain various degrees of PLA polymer modification and various degrees of delay in the PLA elastic modulus modification reaction.

### Example 15

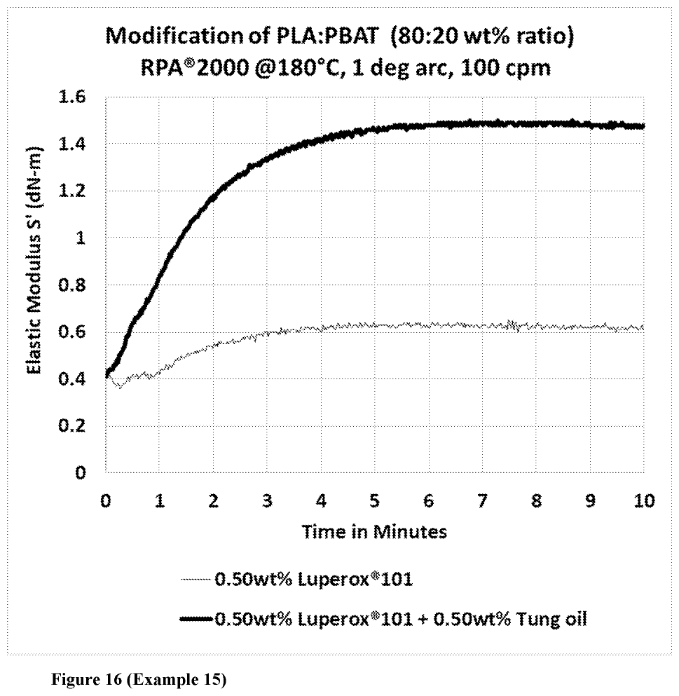

Please refer to FIG. 16 (Example 15). In this example, the unexpected benefit of using tung oil in combination with an organic peroxide to provide a significant increase in the melt strength of a bio-polymer (PLA) and biodegradable polymer (PBAT) melt mixture, as compared to the peroxide used alone, is demonstrated.

In this Example and as shown in the rheographs of FIG. 16, PBAT and PLA were combined, melt blended and modified to increase the elastic modulus (melt strength). A blend of a bio-based polymer with a biodegradable polymer was prepared using an 80:20 wt % ratio of

PLA to PBAT. Thus, in this example two polymers (PLA and PBAT) used at an 80:20 wt % ratio along with various additives were melt blended in an internal Haake internal mixer at 150 ° C. Samples of the melt blended compositions taken from the Haake mixer were reacted and tested in the RPA®2000 rheometer at 180° C., using a 1° arc and a 100 cpm frequency where the elastic modulus was measured in dN-m as before.

Specifically, 0.50 wt % Luperox® 101 peroxide, with and without 0.50 wt % tung oil was added to a PLA and PBAT (80:20) wt % blend and melt mixed at 30 rpm for two minutes at 150° C. using our Haake internal mixer. These premixed PLA samples were then reacted and tested in the RPA®2000 rheometer at 180° C., using a 1° arc strain and 100 cpm frequency. The reaction of tung oil with Luperox® 101 in the PLA-PBAT blend at 180° C. resulted in an unexpected and significant increase in the PLA & PBAT elastic modulus in dN-m. Again this increase in elastic modulus means that the polymer melt strength was increased due to the use of tung oil in combination with the organic peroxide. The amount of increase in the elastic modulus when using tung oil and peroxide, is significantly greater than using only the 0.5 wt % Luperox® 101 peroxide.

If a delay in this tung oil and peroxide modification of PLA & PBAT is desired, one or more of the vitamin K additives, myrcene, CBD isolate, oleuropein or a combination of these additives may be added to obtain a desired delay in the reaction, to facilitate increased melt mixing prior to polymer modification.

1. An organic peroxide formulation comprising:
at least one organic peroxide; and
at least one reactive bio-based additive.

2. The organic peroxide formulation of claim 1, wherein the amount of the reactive bio-based additive and the amount of the at least one organic peroxide are selected such that the formulation is capable of chemically reacting with a bio-based polymer to produce a modified bio-based polymer, or a biodegradable polymer to produce a modified biodegradable polymer, or a mixture of bio-based and biodegradable polymers to produce a mixture of modified bio-based and modified biodegradable polymers.

3. The organic peroxide formulation according to claim 1, wherein the at least one reactive bio-based additive is selected from the group consisting of Vitamin K compounds, derivatives thereof, and mixtures thereof.

4. The organic peroxide formulation according to claim 1, wherein the at least one reactive bio-based additive is selected from the group consisting of plant sourced oils comprising at least one carbon-carbon double bond, animal-sourced oils comprising at least one carbon-carbon double bond, bio-based oils comprising at least one carbon-carbon double bond, bio-derived oils comprising at least one carbon-carbon double bond, and mixtures thereof.

5. The organic peroxide formulation according to claim 1, wherein the at least one organic peroxide is selected from the group consisting of diacyl peroxides (excluding dibenzoyl peroxide); dialkyl peroxides; diperoxyketal peroxides; hemi-perketal peroxides; monoperoxycarbonates; cyclic ketone peroxides; peroxyesters; peroxydicarbonates; and mixtures thereof.

6. The organic peroxide formulation according to claim 1, further comprising at least one crosslinking coagent comprising a moiety having at least two functional groups,
wherein said functional groups may be the same or different and are selected from the group consisting of allylic, methacrylic, acrylic, maleimide, and vinyl.

7. The organic peroxide formulation according to claim 1, further comprising at least one natural or naturally derivable scorch retardant additive selected from the group consisting of Vitamin K1 (phytonadione or phylloquinone), Vitamin K2 (menaquinone), Vitamin K3 (menadione), Vitamin K2 MK-4 (menatetrenone), Vitamin K2 MK-7(menaquinone-7), Vitamin K2 MK-14 (Menaquinone 14), Vitamin K2 menatetrenone epoxide, emodin (6-methyl-1,3,8-trihydroxyanthraquinone), parietin or physcion (1,8-dihydroxy-3-methoxy-6-methyl-anthracene-9,10-dione), rhein (4,5-dihydroxy-9,10-dioxoanthracene-2-carboxylic acid), aloe-emodin (1,8-dihydroxy-3-(hydroxymethyl)anthraquinone), chrysophanol (1,8-dihydroxy-3-methyl-9,10-anthraquinone), chimaphilin (2,7-dimethyl-1,4-naphthoquinone), thymoquinone, dithymoquinone, thymolhydroquinone, 2-hydroxy-2,4-napthoquinone, caffeoquinone (caffeic acid quinone), chlorogenic acid quinone, olive leaf oil (oleuropein), quinine, caffeic acid, chlorogenic acid, cannabidiol, thymol, cystine, cysteine, homocysteine, methionine, taurine, N-formyl methionine, and mixtures thereof.

8. A formulation for producing a modified bio-based polymer, a modified biodegradable polymer, or a mixture thereof, said formulation comprising at least one organic peroxide, at least one bio-based polymer, or at least one biodegradable polymer, or a mixture thereof, wherein the amount of the at least one bio-based polymer, biodegradable polymer, or mixture thereof and the amount of the at least one organic peroxide are selected such that the formulation is capable of chemically reacting with a reactive bio-based additive to produce the modified bio-based polymer, the modified biodegradable polymer, or the mixture thereof.

9. The formulation for producing the modified bio-based polymer, biodegradable polymer, or mixture thereof, according to claim 8, wherein the at least one organic peroxide is selected from the group consisting of diacyl peroxides (excluding dibenzoyl peroxide); dialkyl peroxides; diperoxyketal peroxides, hemi-perketal peroxides, monoperoxycarbonates, cyclic ketone peroxides, peroxyesters, peroxydicarbonates, and mixtures thereof.

10. The formulation for producing the modified bio-based polymer, modified biodegradable polymer, or mixture thereof, according to claim 8, wherein the at least one bio-based polymer is selected from the group consisting of polylactic acid (PLA) and copolymers thereof, polyhydroxyalkanoates (PHAs), polyhydroxybutyrate (PHB), poly(3-hydroxy valerate) (PHV), polyhydroxyhexanoate (PHH), polyglycolic acid (PGA), and poly-ε-caprolactone (PCL) and derivatives and mixtures thereof, the biodegradable polymer is poly(butylene adipate-co-terephthalate) (PBAT) including derivatives thereof.

11. The formulation for producing a modified biodegradable polymer according to claim 8, wherein the formulation consists essentially of biodegradable polymer poly(butylene adipate-co-terephthalate) (PBAT) and derivatives thereof.

12. The formulation for producing a modified bio-based polymer according to claim 8, wherein the at least one bio-based polymer is combined with biodegradable polymer poly(butylene adipate-co-terephthalate) (PBAT).

13. The formulation for producing a modified bio-based polymer, a modified biodegradable polymer, or mixture thereof according to claim 8, wherein the at least one reactive bio-based additive is selected from the group consisting of Vitamin K compounds, derivatives thereof, and mixtures thereof.

14. The formulation for producing a modified bio-based polymer, a modified biodegradable polymer, or a mixture thereof according to claim 8, wherein the at least one bio-based additive is selected from the group consisting of plant sourced oils comprising at least one carbon-carbon double bond, animal-sourced oils comprising at least one carbon-carbon double bond, bio-based oils comprising at least one carbon-carbon double bond, bio-derived oils comprising at least one carbon-carbon double bond, and mixtures thereof.

15. The formulation for producing a modified bio-based polymer, a modified biodegradable polymer, or a mixture thereof according to claim 8, further comprising at least one crosslinking coagent comprising a moiety having at least two functional groups, wherein said functional groups are the same or different and are selected from the group consisting of allylic,methacrylic, acrylic, maleimide and vinyl.

16. A modified bio-based polymer, a modified biodegradable polymer, or a mixture thereof, comprising a reaction product of: at least one organic peroxide, at least one reactive bio-based additive, and: at least one bio-based polymer, or at least one biodegradable polymer, or a mixture of said bio-based polymer and biodegradable polymer.

17. The modified bio-based polymer, modified biodegradable polymer, or mixture thereof, according to claim 16, wherein the at least one organic peroxide is selected from the group consisting of diacyl peroxides (excluding dibenzoyl peroxide), dialkyl peroxides, diperoxyketal peroxides, hemi-perketal peroxides, monoperoxycarbonates, cyclic ketone peroxides, peroxyesters, peroxydicarbonates, and mixtures thereof.

18. The modified bio-based polymer, modified biodegradable polymer, or mixture thereof, according to claim 16, wherein the at least one reactive bio-based additive is selected from the group consisting of Vitamin K compounds including derivatives and mixtures thereof.

19. The modified bio-based polymer, modified biodegradable polymer, or mixture thereof, according to claim 16, wherein the at least one reactive bio-based additive is selected from the group consisting of plant sourced oils comprising at least one carbon-carbon double bond, animal-sourced oils comprising at least one carbon-carbon double bond, bio-based oils comprising at least one carbon-carbon double bond, bio-derived oils comprising at least one carbon-carbon double bond, and mixtures thereof.

20. The modified bio-based polymer, modified biodegradable polymer, or mixture thereof, according to claim 16, wherein the at least one bio-based polymer is selected from the group consisting of polylactic acid (PLA) and copolymers thereof, polyhydroxyalkanoates (PHAs), polyhydroxybutyrate (PHB), poly(3-hydroxy valerate) (PHV), polyhydroxyhexanoate (PHH), polyglycolic acid (PGA), and poly-ε-caprolactone (PCL), including derivatives and mixtures thereof, and the at least one biodegradable polymer is poly(butylene adipate-co-terephthalate) (PBAT), including derivatives thereof.

21. The modified biodegradable polymer according to claim 16 wherein the at least one bio-based polymer is combined with poly(butylene adipate-co-terephthalate) (PBAT), including derivatives thereof.

22. A method of producing a modified bio-based polymer, a modified biodegradable polymer, of a mixture thereof, the method comprising:
combining:
at least one organic peroxide;
at least one reactive bio-based additive; and
at least one bio-based polymer, or at least biodegradable polymer, of a mixture of bio-based and biodegradable polymer;
thereby forming a reaction mixture; and
reacting the reaction mixture to form a modified bio-based polymer.

23. The method according to claim 22, wherein the combining step comprises:
a first step of combining the at least one organic peroxide and the at least one reactive bio-based additive to form an organic-peroxide-reactive bio-based additive formulation; and
a second step of combining the organic-peroxide-reactive bio-based additive formulation with the at least one bio-based polymer, biodegradable polymer, or mixture of bio-based and bioidegradable polymer, to form the reaction mixture.

24. The method according to claim 23, wherein the second step and the reacting step are performed at the same time.

25. The method according to claim 22, wherein the combining step comprises:
a first step of combining the at least one organic peroxide and the at least one bio-based polymer, biodegradable polymer, or mixture thereof, to form an organic-peroxide-bio-based, biodegradable, or mixture thereof polymer formulation; and
a second step of combining the at least one reactive bio-based reactive additive to form the reaction mixture.

26. The method according to claim 25, wherein the second step and the reacting step are performed at the same time.

27. The organic peroxide formulation according to claim 1, wherein the at least one reactive bio-based additive is selected from the group consisting of tung oil, myrcene, cannabidiol, limonene and omega 3.
